(19) United States
(12) Patent Application Publication
(10) Pub. No.: US 2011/0096306 A1
(43) Pub. Date: Apr. 28, 2011

(54) STAGE APPARATUS, EXPOSURE APPARATUS, DRIVING METHOD, EXPOSING METHOD, AND DEVICE FABRICATING METHOD

(75) Inventor: Hiromitsu YOSHIMOTO, Saitama-shi (JP)

(73) Assignee: NIKON CORPORATION, Tokyo (JP)

(21) Appl. No.: 12/887,915

(22) Filed: Sep. 22, 2010

Related U.S. Application Data
(60) Provisional application No. 61/272,472, filed on Sep. 28, 2009.

(51) Int. Cl. G03B 27/62

(52) U.S. Cl. 355/30; 355/75; 355/77

(57) ABSTRACT

A stage apparatus includes a guide member that extends in first directions, that moves in second directions, which are substantially orthogonal to the first directions; two second moving bodies, which are provided along the guide member such that they are independently moveable in the first directions, that move in the second directions together with the guide member by the movement of the first moving body; and a holding member that holds an object and is supported by the two second moving bodies such that it is capable of moving within a two dimensional plane that includes at least the first directions and the second directions.

### CROSS-REFERENCE TO RELATED APPLICATION

This application is a non-provisional application claiming priority to and the benefit of U.S. provisional application No. 61/272,472, filed Sep. 28, 2009. The entire contents of which are incorporated herein by reference.

### BACKGROUND

The present invention relates to a stage apparatus, an exposure apparatus, a driving method, an exposing method, and a device fabricating method.

Conventionally, lithographic processes that fabricate electronic devices (i.e., microdevice), such as semiconductor devices (i.e., integrated circuits and the like) and liquid crystal display devices, principally use step-and-repeat type projection exposure apparatuses (i.e., so-called steppers), step-and-scan type projection exposure apparatuses (i.e., so-called scanning steppers or scanners), or the like.

Wafers that undergo exposure and substrates like glass plates that are used in various exposure apparatuses have been increasing in size with time (e.g., wafers have increased in size every 10 years). Presently, the mainstream wafer has a diameter of 300 mm, and the era of a wafer with a diameter of 450 mm is nearing. When the industry transitions to the 450 mm wafer, the number of dies (i.e., chips) yielded by one wafer will increase to more than double that of the current 300 mm wafer, which will help reduce costs. In addition, it is anticipated that the effective utilization of energy, water, and other resources will further reduce the total resources consumed per chip.

Moreover, given that increasing the size of the wafer to 450 mm will also increase the number of dies (i.e., chips) yielded by one wafer, the time required to expose one wafer will increase, thereby reducing throughput. Accordingly, one method of minimizing the reduction in throughput is to adopt a twin stage system (e.g., refer to U.S. Pat. No. 6,590,634, U.S. Pat. No. 5,969,441, U.S. Pat. No. 6,208,407 and the like), wherein an exposing process is performed on a wafer on one wafer stage while another process, such as a wafer exchanging process or a wafer aligning process, is performed on a separate wafer stage.

### SUMMARY

Nevertheless, the related art discussed above has the following problems.

Because a 450 mm wafer is thin and has a large surface area, exchanging such a wafer on a wafer stage using a conventional wafer exchanging apparatus without modification is difficult; furthermore, even if a specialized exchanging apparatus is used, the exchange is time consuming; accordingly, even in the case of a twin stage type exposure apparatus, there is a risk that improving throughput sufficiently will not necessarily be possible.

In addition, this problem is not limited to twin stage type exposure apparatuses, but equally pertains to exposure apparatuses with only one stage.

A purpose of aspects of the present invention is to provide a stage apparatus, an exposure apparatus, a driving method, an exposing method, and a device fabricating method that can help improve throughput.

A stage apparatus according to an aspect of the present invention comprises: a first moving body, which comprises a guide member that extends in first directions, that moves in second directions, which are substantially orthogonal to the first directions; two second moving bodies, which are provided along the guide member such that they are independently moveable in the first directions, that move in the second directions together with the guide member by the movement of the first moving body; and a holding member that holds an object and is supported by the two second moving bodies such that it is capable of moving within a two dimensional plane that includes at least the first directions and the second directions.

An aspect of the present invention provides an exposure apparatus, which exposes with an energy beam an object held by a stage apparatus, wherein a stage apparatus as recited above serves as the stage apparatus.

An aspect of the present invention provides a driving method that moves a holding member, which holds an object, within a two-dimensional plane that includes first directions and second directions orthogonal to the first directions, comprising: a step that moves the first moving body, which comprises a guide member that extends in the first directions, in the second directions; a step that moves two second moving bodies, which are provided such that they move independently in the first directions along the guide member, in the second directions together with the guide member by the movement of the first moving body; and a step that supports the holding member, which holds the object, by the two second moving bodies, synchronously moves the two second moving bodies along the guide member, and moves the holding member in the first directions.

An aspect of the present invention provides an exposing method that drives a stage, which holds an object, exposes the object with an energy beam, and comprises the step of driving the stage using a driving method recited above.

According to aspects of the present invention, throughput even when a large substrate is processed can be improved.

### BRIEF DESCRIPTION OF THE DRAWINGS

FIG. 1 schematically shows the configuration of an exposure apparatus of one embodiment.

FIG. 2 is a partial plan view that schematically shows the exposure apparatus shown in FIG. 1.

FIG. 3 is an enlarged view of the vicinity of a center table shown in FIG. 1.

FIG. 4 is an external oblique view of a stage apparatus.

FIG. 5 is a partial exploded oblique view of the stage apparatus.

FIG. 6 is a block diagram that shows the configuration of a control system of the exposure apparatus shown in FIG. 1.

FIG. 7 is a view for explaining a movable blade provided by the exposure apparatus in FIG. 1.

FIG. 8 includes front views of a wafer stage shown in isolation from an X coarse motion stage.

FIG. 9 is a plan view that shows the wafer stage.

FIG. 10 is a plan view that shows the arrangement of magnet units and a coil unit that constitute a fine motion stage drive system.

FIG. 11A is a side view, viewed from the −Y direction, that shows the arrangement of the magnet units and the coil unit that constitute the fine motion stage drive system.

FIG. 11B is a side view, viewed from the +X direction, that shows the arrangement of the magnet units and the coil unit that constitute the fine motion stage drive system.

FIG. 12A is for explaining the drive principle by which a fine motion stage is driven in the Y axial directions.

FIG. 12B is for explaining the drive principle by which the fine motion stage is driven in the Z axial directions,

FIG. 12C is for explaining the drive principle by which the fine motion stage is driven in the X axial directions.

FIG. 13A is for explaining a method of driving a wafer during a scanning exposure.

FIG. 13B is for explaining a method of driving the wafer during stepping.

FIG. 14 is for explaining first and second parallel processes, which are performed using fine motion stages.

FIG. 15 is for explaining the transfer of an immersion space (i.e., a liquid Lq) between the fine motion stage and the movable blade.

FIG. 16 is for explaining the transfer of the immersion space (i.e., the liquid Lq) between the fine motion stage and the movable blade.

FIG. 17 is for explaining the transfer of the immersion space (i.e., the liquid Lq) between the fine motion stage and the movable blade.

FIG. 18 is for explaining the transfer of the immersion space (i.e., the liquid Lq) between the fine motion stage and the movable blade.

FIG. 19A includes views for explaining the parallel processes, which are performed using the fine motion stages.

FIG. 19B includes views for explaining the parallel processes, which are performed using the fine motion stages.

FIG. 19C includes views for explaining the parallel processes, which are performed using the fine motion stages.

FIG. 19D includes views for explaining the parallel processes, which are performed using the fine motion stages.

FIG. 20 is a plan view that corresponds to the state shown in FIG. 19B.

FIG. 21 is a view for explaining the parallel processes, which are performed using the fine motion stages.

FIG. 22A is a view for explaining the parallel processes, which are performed using the fine motion stages.

FIG. 22B is a view for explaining the parallel processes, which are performed using the fine motion stages.

FIG. 23 is a view for explaining the parallel processes, which are performed using the fine motion stages.

FIG. 24 is a view for explaining the parallel processes, which are performed using the fine motion stages.

FIG. 25 is a view for explaining the parallel processes, which are performed using the fine motion stages.

FIG. 26 is a view for explaining the parallel processes, which are performed using the fine motion stages.

FIG. 27 is a view for explaining the parallel processes, which are performed using the fine motion stages.

FIG. 28 is a flow chart that depicts one example of a process of fabricating a microdevice.

FIG. 29 depicts one example of the detailed process of a wafer processing step described in FIG. 28.

### DESCRIPTION OF EMBODIMENTS

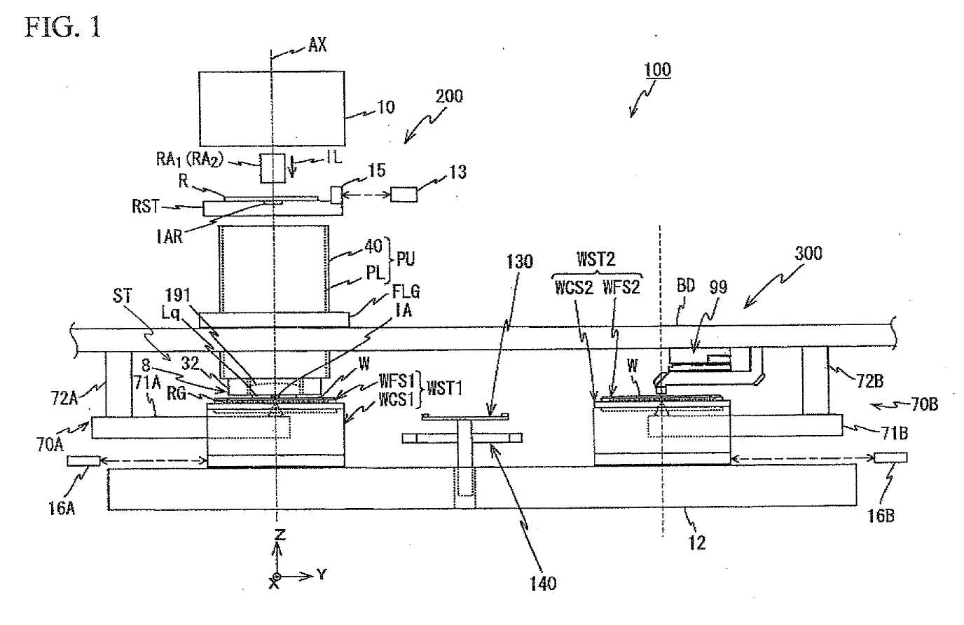

The following text explains a stage apparatus, an exposure apparatus, a driving method, an exposing method, and a device fabricating method according to embodiments of the present invention, referencing FIG. 1 through FIG. 29.

FIG. 1 schematically shows the configuration of an exposure apparatus 100 according to one embodiment. The exposure apparatus 100 is a step-and-scan-type projection exposure apparatus, namely, a so-called scanner. In the present embodiment as discussed below, a projection optical system PL is provided; furthermore, in the explanation below, the directions parallel to an optical axis AX of the projection optical system PL are the Z axial directions, the directions within a plane that is orthogonal thereto and wherein a reticle and a wafer are scanned relative to one another are the Y axial directions, the directions that are orthogonal to the Z axis and the Y axis are the X axial directions, and the rotational (i.e., tilt) directions around the X axis, the Y axis, and the Z axis are the θx, the θy, and the θz directions, respectively.

As shown in FIG. 1, the exposure apparatus 100 comprises: an exposure station 200 (i.e., a processing position), which is disposed on a base plate 12 in the vicinity of the −Y (side end part thereof; a measurement station 300 (i.e., a processing position), which is disposed on the base plate 12 in the vicinity of the +Y side end part thereof; a center table 130 (i.e., a support apparatus), which is disposed between the measurement station 300 and the exposure station 200; a stage apparatus ST, which comprises two wafer stages WST1, WST2; and a control system that controls these elements. Here, the base plate 12 is supported substantially horizontally (i.e., parallel to the XY plane) on a floor surface by a vibration isolating mechanism (not illustrated). The base plate 12 comprises a flat plate shaped member, whose upper surface is finished to an extremely high degree of flatness, and serves as a guide surface when the wafer stages WST1, WST2 are moved.

The exposure station 200 comprises an illumination system 10, a reticle stage RST, a projection unit PU, and a local liquid immersion apparatus 8.

As disclosed in, for example, U.S. patent Application Publication No. 2003/0025890, the illumination system 10 comprises an illumination optical system that comprises: a light source; a luminous flux intensity uniformizing optical system, which includes an optical integrator and the like; and a reticle blind (none of which are shown). The illumination system 10 illuminates, with illumination light IL (i.e., exposure light, an energy beam, etc.) at a substantially uniform luminous flux intensity, a slit shaped illumination area IAR, which is defined by a reticle blind (also called a masking system), on a reticle R. Here, as one example, ArF excimer laser light (with a wavelength of 193 nm) is used as the illumination light IL.

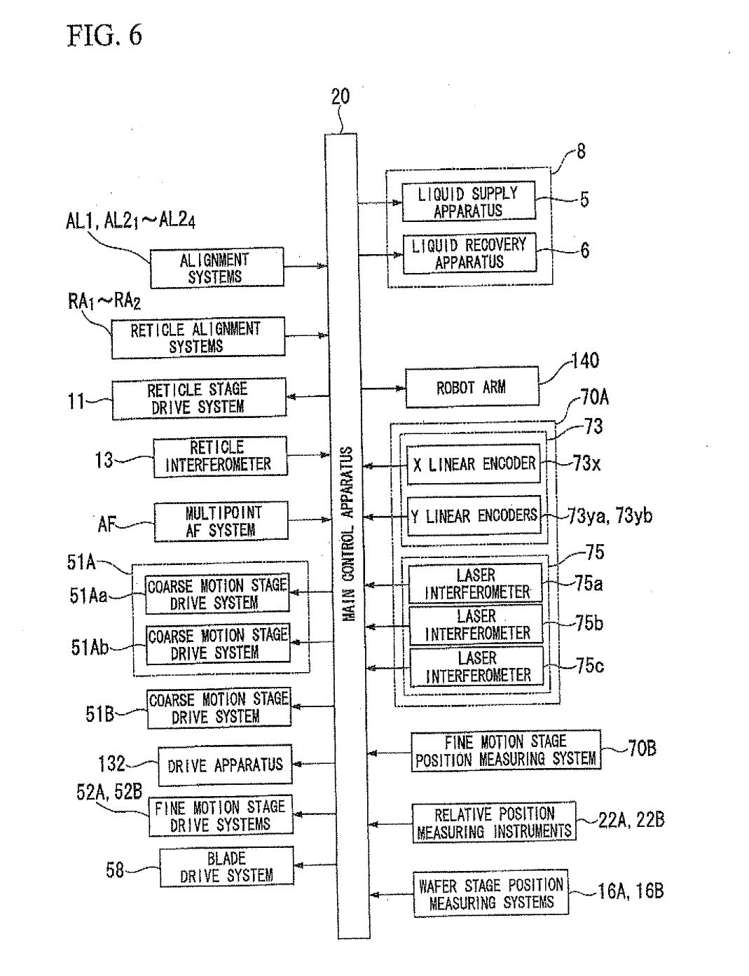

The reticle R, whose patterned surface (i.e., in FIG. 1, a lower surface) has a circuit pattern and the like formed thereon, is fixed onto the reticle stage RST by, for example, vacuum chucking. A reticle stage drive system 11 (not shown in FIG. 1; refer to FIG. 6) that comprises, for example, linear motors is capable of driving the reticle stage RST finely within an XY plane and at a prescribed scanning speed in scanning directions (i.e., in the Y axial directions, which are the lateral directions within the paper plane of FIG. 1).

A reticle laser interferometer 13 (hereinbelow, called a “reticle interferometer”) continuously detects, with a resolving power of, for example, approximately 0.25 nm, the position (including rotation in the θz directions) of the reticle stage RST within the XY plane via movable mirrors 15, which are fixed to the reticle stage RST. Measurement values of the reticle interferometer 13 are sent to a main control apparatus 20 (not shown in FIG. 1; refer to FIG. 6).

The projection unit PU is disposed below the reticle stage RST in FIG. 1. The projection unit PU is supported by a main frame BD, which is supported horizontally by a support member (not shown), via a flange part FLG, which is provided to an outer circumferential part of the main frame BD. The projection unit PU comprises a lens barrel 40 and the projection optical system PL, which comprises a plurality of optical elements that are held in the lens barrel 40. A dioptric optical system that is, for example, double telecentric and has a prescribed projection magnification (e.g., ¼×, ⅕×, or ⅛×) is used as the projection optical system PL. Consequently, when the illumination light IL from the illumination system 10 illuminates the illumination area IAR on the reticle R, the illumination light IL that passes through the reticle R, whose patterned surface is disposed substantially coincident with a first plane (i.e., the object plane) of the projection optical system PL, travels through the projection optical system PL (i.e., the projection unit PU) and forms a reduced image of a circuit pattern of the reticle R that lies within that illumination area IAR (i.e., a reduced image of part of the circuit pattern) on a wafer W (i.e., an object), which is disposed on a second plane side (i.e., the image plane side) of the projection optical system PL and whose front surface is coated with a resist (i.e., a sensitive agent), in an area IA (hereinbelow, also called an “exposure area”) that is conjugate with the illumination area IAR.

Furthermore, a scanning exposure is performed on one shot region (i.e., a block area) on the wafer W, and a pattern of the reticle R is thereby transferred to that shot region by synchronously driving the reticle stage RST, which holds the reticle R, and a wafer fine motion stage WFS1 (or WFS2) (i.e., a holding member; hereinbelow, abbreviated as “fine motion stage”), which holds the wafer W, so as to move the reticle R relative to the illumination area IAR (i.e., the illumination light IL) in the scanning directions (i.e., the Y axial directions) and to move the wafer W relative to the exposure area IA (i.e., the illumination light IL) in the scanning directions (i.e., the Y axial directions). Namely, in the present embodiment, the pattern of the reticle R is created on the wafer W by the illumination system 10 and the projection optical system PL, and that pattern is formed on the wafer W by exposing a sensitive layer (i.e., a resist layer) on the wafer W with the illumination light IL.

The local liquid immersion apparatus 8 (i.e., the liquid immersion apparatus) comprises a liquid supply apparatus 5 and a liquid recovery apparatus 6 (both of which are not shown in FIG. 1; refer to FIG. 6) as well as a nozzle unit 32 (i.e., a liquid immersion member). As shown in FIG. 1, the nozzle unit 32 is suspended from the main frame BD, which supports the projection unit PU and the like, via a support member (not shown) such that the nozzle unit 32 surrounds a lower end part of the lens barrel 40 that holds the optical element (i.e., the optical member)—of the optical elements that constitute the projection optical system PL—that is most on the image plane side (i.e., the wafer W side), here, a lens 191 (hereinbelow, also called a “tip lens”). In the present embodiment, the main control apparatus 20 controls both the liquid supply apparatus 5 (refer to FIG. 6), which via the nozzle unit 32 supplies a liquid to the space between the tip lens 191 and the wafer W, and the liquid recovery apparatus 6 (refer to FIG. 6), which via the nozzle unit 32 recovers the liquid from the space between the tip lens 191 and the wafer W. At this time, the main control apparatus 20 controls the liquid supply apparatus 5 and the liquid recovery apparatus 6 such that the mount of the liquid supplied and the amount of the liquid recovered are always equal. Accordingly, a fixed amount of a liquid Lq (refer to FIG. 1) is continuously being replaced and held between an emergent surface of the tip lens 191 and the wafer W. In the present embodiment, it is understood that pure water, through which ArF excimer laser light (i.e., light with a wavelength of 193 nm) transmits, is used as the abovementioned liquid,

In addition, the exposure station 200 is provided with a fine motion stage position measuring system 70A (i.e., a measuring apparatus, first measuring apparatus) that comprises a measuring arm 71A, which is supported in a substantially cantilevered state (i.e., the vicinity of one-end part is supported) from the main frame BD via a support member 72A. However, for the sake of convenience, the fine motion stage position measuring system 70A will be explained after the fine motion stages (discussed below) are explained.

The measurement station 300 comprises: an alignment apparatus 99, which is fixed to the main frame BD in a suspended state; and a fine motion stage position measuring system 70B (i.e., a measuring apparatus, second measuring apparatus) that comprises a measuring arm 71B, which is supported in a cantilevered state (i.e., the vicinity of one-end part is supported) from the main frame BD via a support member 72B. The fine motion stage position measuring system 70B is configured identically to the fine motion stage position measuring system 70A discussed above, except that it is oriented in the opposite direction.

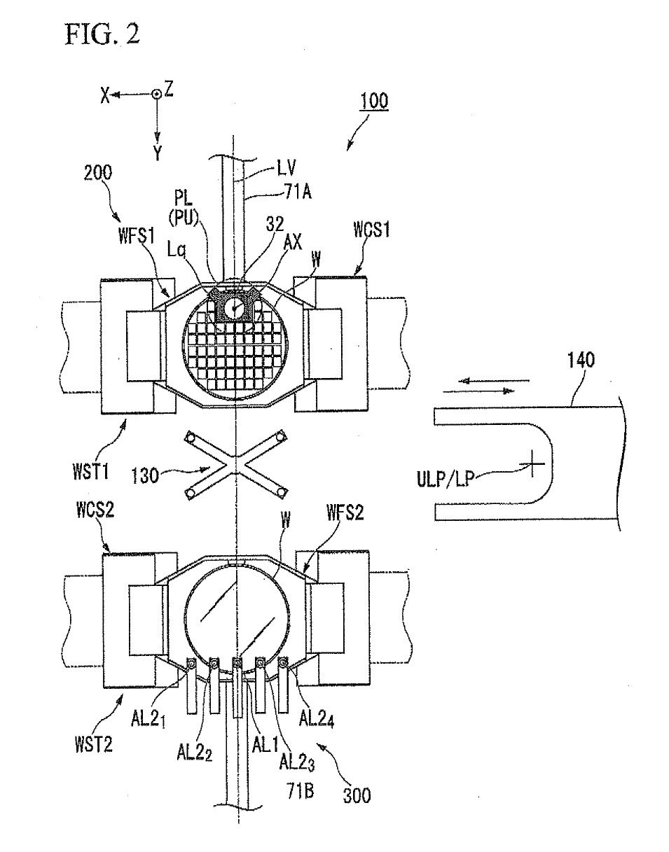

The alignment apparatus 99 comprises five alignment systems AL1, AL2₁-AL2₄ as shown in FIG. 2. In detail, as shown in FIG. 2, the primary alignment system AL1 is disposed along a straight line LV (hereinbelow, called a reference axis), which is parallel to the Y axis and passes through the center of the projection unit PU (i.e., the optical axis AX of the projection optical system PL; in the present embodiment, this center also coincides with the center of the exposure area IA discussed above), such that its center of detection is positioned spaced apart from the optical axis AX on the +Y side by a prescribed distance. The secondary alignment systems AL2₁, AL2₂ and AL2₃, AL2₄, whose centers of detection are disposed substantially symmetrically with respect to the reference axis LV, are provided on either side of the primary alignment system AL1 in the X axial directions such that the primary alignment system AL1 is interposed therebetween. Namely, the centers of detection of the five alignment systems AL1, AL2₁-AL2₄ are disposed along the X axial directions. The secondary alignment systems AL2₁, AL2₂, AL2₃, AL2₄ are held by a holding apparatus (i.e., a slider), which is capable of moving within the XY plane. Each of the alignment systems AL1, AL2₁-AL2₄ is an image processing type field image alignment (FIA) system. The signals that represent the images captured by the alignment systems AL1, AL2₁-AL2₄ are supplied to the main control apparatus 20 (refer to FIG. 6); further, in FIG. 1, the five alignment systems AL1, AL2₁-AL2₄ and the holding apparatus (i.e., the slider) that hold them are collectively shown as the alignment apparatus 99. Furthermore, the detailed configuration of the alignment apparatus 99 is disclosed in, for example, PCT International Publication No. WO 2008/056735.

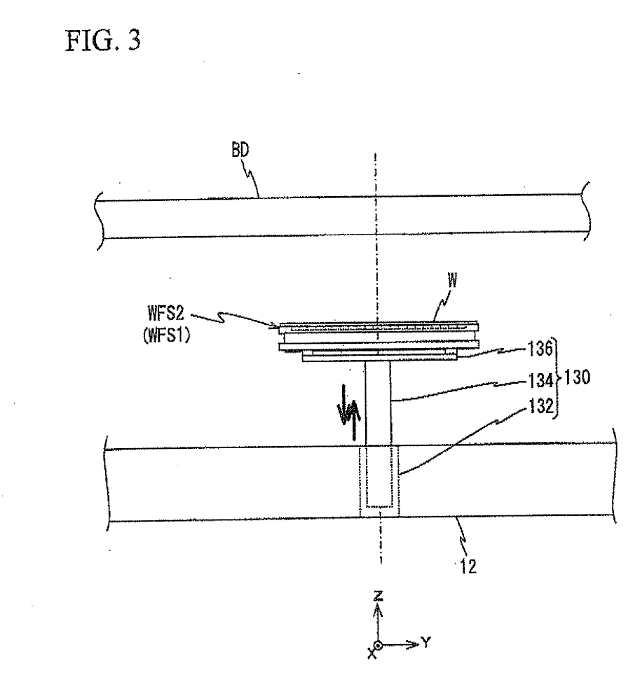

As shown in FIG. 2, the center table 130 is disposed on the reference axis LV discussed above such that it substantially coincides with the center thereof at a position between the measurement station 300 and the exposure station 200. As shown in FIG. 3, the center table 130 comprises a drive apparatus 132, which is disposed inside the base plate 12, a shaft 134, which the drive apparatus 132 drives vertically, and a table main body 136, which is fixed to an upper end of the shaft 134 and is X shaped in a plan view. The main control apparatus 20 (refer to FIG. 6) controls the drive apparatus 132 of the center table 130.

The exposure apparatus 100 of the present embodiment comprises a robot arm 140 that transports the fine motion stage WFS1 or WFS2, which is mounted on the table main body 136, to an unloading position-cum-loading position, namely, a wafer exchange position ULP/LP, which is for exchanging wafers (refer to FIG. 1 and FIG. 2). The main control apparatus 20 (refer to FIG. 6) controls the robot arm 140.

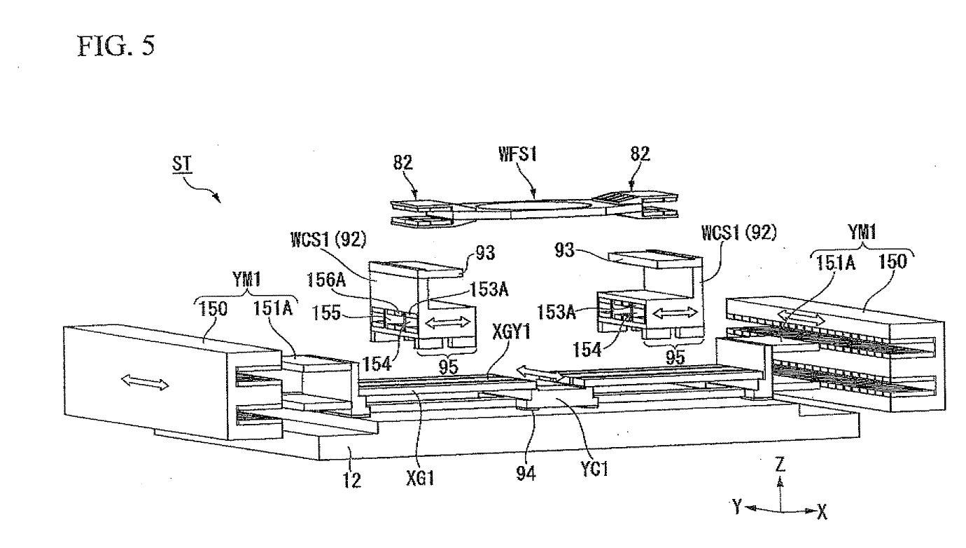

As shown in FIG, 4 and FIG. 5, the stage apparatus ST comprises: a Y coarse motion stage YC1 (i.e., a first moving body), which is driven by Y motors YM1; a Y coarse motion stage YC2 (i.e., another first moving body), which is driven by Y motors YM2; a pair of X coarse motion stages WCS1 (i.e., second moving bodies), which are independently driven by X motors XM1; a pair of X coarse motion stages WCS2 (i.e., other second moving bodies), which are independently driven by X motors XM2; the fine motion stage WFS1, which holds the wafer W and is moveably supported by the X coarse motion stages WCS1; and the fine motion stage WFS2, which holds the wafer W and is moveably supported by the X coarse motion stages WCS2.

The Y coarse motion stage YC1 and the X coarse motion stages WCS1 constitute a first stage unit SU1, and the Y coarse motion stage YC2 and the X coarse motion stages WCS2 constitute a second stage unit SU2.

The pair of X coarse motion stages WCS1 and the fine motion stage WFS1 constitute the wafer stage WST1 discussed above. Likewise, the pair of X coarse motion stages WCS2 and the fine motion stage WFS2 constitute the wafer stage WST2 discussed above. The fine motion stages WFS1, WFS2 are driven by fine motion stage drive systems 52A (i.e., drive apparatuses) (refer to FIG. 6) in the X, Y, Z, θx, θy, and θz directions, which correspond to six degrees of freedom, with respect to the X coarse motion stages WCS1, WCS2, respectively.

A wafer stage position measuring system 16A measures the position within the XY plane (including the rotation in the θz directions) of the wafer stage WST1 (i.e., the coarse motion stages WCS1). In addition, the fine motion stage position measuring system 70A measures the position of the fine motion stage WFS1 (or the fine motion stage WFS2), which the coarse motion stages WCS1 in the exposure station 200 support, in the directions corresponding to six degrees of freedom (i.e., the X, Y, Z, θx, θy, and θz directions). The measurement results of the wafer stage position measuring system 16A and the fine motion stage position measuring system 70A are supplied to the main control apparatus 20 (refer to FIG. 6) to control the positions of the X coarse motion stages WCS1 and the fine motion stage WFS1 (or WFS2). A wafer stage position measuring system 16B measures the position within the XY plane (including the rotation in the θz directions) of the wafer stage WST2 (i.e., the X coarse motion stages WCS2). In addition, the fine motion stage position measuring system 70B measures the position of the fine motion stage WFS2 (or WFS1), which the X coarse motion stages WCS2 in the measurement station 300 support, in the directions corresponding to six degrees of freedom (i.e., the X, Y, Z, θx, θy, and θz directions). The measurement results of the wafer stage position measuring system 16B and the fine motion stage position measuring system 70B are supplied to the main control apparatus 20 (refer to FIG. 6) to control the positions of the X coarse motion stages WCS2 and the fine motion stage WFS2 (or WFS1).

When the fine motion stage WFS1 (or WFS2) is supported by the X coarse motion stages WCS1, a relative position measuring instrument 22A (refer to FIG. 6), which is provided between the coarse motion stages WCS1 and the fine motion stage WFS1 (or WFS2), can measure the relative position of the fine motion stage WFS1 (or WFS2) and the coarse motion stages WCS1 in the X, Y, and θz directions, which correspond to three degrees of freedom. Likewise, when the fine motion stage WFS2 (or WFS1) is supported by the coarse motion stages WCS2, a relative position measuring instrument 22B (refer to FIG. 6), which is provided between the coarse motion stages WCS2 and the fine motion stage WFS2 (or WFS1), can measure the relative position of the fine motion stage WFS2 (or WFS1) and the coarse motion stages WCS2 in the X, Y, and θz directions, which correspond to three degrees of freedom.

It is possible to use as the relative position measuring instruments 22A, 22B, for example, encoders wherein gratings provided to the fine motion stages WFS1, WFS2 serve as measurement targets, each of the X coarse motion stages WCS1, WCS2 is provided with at least two beads, and the positions of the fine motion stages WFS1, WFS2 in the X axial directions, the Y axial directions, and the θz directions are measured based on the outputs of these heads. The measurement results of the relative position measuring instruments 22A, 22B are supplied to the main control apparatus 20 (refer to FIG. 6).

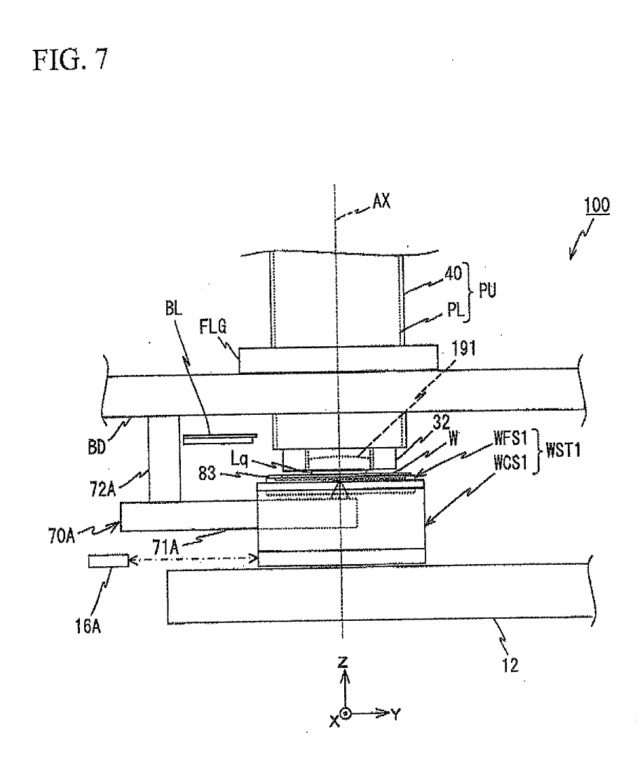

Furthermore, in the exposure apparatus 100 of the present embodiment as shown in FIG. 7, a movable blade BL is provided in the vicinity of the projection unit PU. The movable blade BL can be driven in the Z axial directions and the Y axial directions by a blade drive system 58 (not shown in FIG. 7; refer to FIG. 6). The movable blade BL consists of a plate shaped member wherein a projecting part that projects from another portion is formed in a +Y side upper end part.

In the present embodiment, the upper surface of the movable blade BL is liquid repellent with respect to the liquid Lq. In the present embodiment, the movable blade BL comprises: a base material made of a metal, such as stainless steel; and a film, which is made of a liquid repellent material, that is formed on the surface of the base material. Examples of liquid repellent materials include tetrafluoroethylene-perfluoro (alkyl vinyl ether) copolymer (PFA), polytetrafluoroethylene (FIFE), and Teflon®. Furthermore, the material with which the film is formed may be an acrylic resin or a silicon based resin. In addition, the entire movable blade BL may be formed from at least one material selected from the group consisting of PFA, PTFE, Teflon®, acrylic resin, and silicon based resin. In the present embodiment, the contact angle of the liquid Lq with respect to the upper surface of the movable blade BL is, for example, 90° or greater.

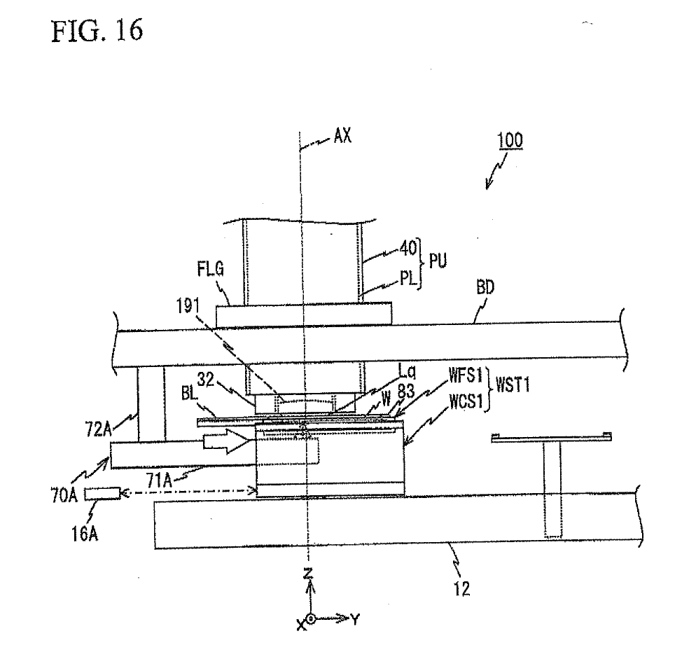

The movable blade BL is capable of engaging with the fine motion stage WFS1 (or WFS2), which is supported by the coarse motion stages WCS1, from the −Y side; furthermore, in that engaged state (erg., refer to FIG. 16), the movable blade BL forms an apparently integrated and completely flat surface with the upper surface of the fine motion stage WFS1 (or WFS2). The main control apparatus 20 uses the blade drive system 58 to drive the movable blade BL, which transfers an immersion space (i.e., the liquid Lq) to and from the fine motion stage WFS1 (or WFS2). Furthermore, the transfer of the immersion space (i.e., the liquid Lq) between the movable blade BL and the fine motion stage WFS1 (or WFS2) is discussed further below.

In addition, in the exposure apparatus 100 of the present embodiment, a pair of image processing type reticle alignment systems RA1, RA2 (in FIG. 1, the reticle alignment system RA2 is hidden on the paper plane far side of the reticle alignment system RA1) is disposed above the reticle stage RST; furthermore, each of the processing type reticle alignment systems RA1, RA2 comprises an image capturing device such as a CCD and uses light (in the present embodiment, the illumination light IL) of the exposure wavelength as the illumination light for alignment, as disclosed in detail in, for example, U.S. Pat. No. 5,646,413. In a state wherein, a measuring plate (discussed below) is positioned on the fine motion stage WFS1 (or WFS2) directly below the projection optical system PL, the main control apparatus 20 uses the pair of reticle alignment systems RA1, RA2 to detect, through the projection optical system PL, a pair of first fiducial marks on the measuring plate corresponding to a projected image of a pair of reticle alignment marks (not illustrated) formed on the reticle R; thereby, the positional relationship between the center of the projection area of the pattern of the reticle R formed by the projection optical system PL and the reference position on the measuring plate, namely, the position between the centers of the two first fiducial marks, is detected. The detection signals of the reticle alignment systems RA1, RA2 are supplied to the main control apparatus 20 (refer to FIG. 6) via a signal processing system (not shown).

Next, the configuration of each part of the stage apparatus ST will be discussed in detail.

Furthermore, in FIG. 5, to facilitate understanding, only the configuration of the vicinity of the first stage unit SU1 is illustrated. In addition, because the configuration of the vicinity of the second stage unit SU2 is the same as that of a wafer stage WST1 and its vicinity, the following text explains only the wafer stage WST1.

The Y motors YM1 comprise stators 150, which are provided on both side ends of the base plate 12 in the X directions such that they extend in the Y directions, and sliders 151A, which are provided on both ends of the Y coarse motion stage YC1 in the X directions. The Y motors YM2 comprise the abovementioned stators 150 and sliders 151B, which are provided on both ends of the Y coarse motion stage YC2 in the X directions. Namely, the Y motors YM1, YM2 are configured such that they share the stators 150. The stators 150 comprise permanent magnets, which are arrayed in the Y directions, and the sliders 151A, 151B comprise coils, which are arrayed in the Y directions. Namely, the Y motors YM1, YM2 are moving coil type linear motors that drive both the wafer stages WST1, WST2 and the Y coarse motion stages YC1, YC2 in the Y directions. Furthermore, while the above text explains an exemplary case of moving coil type linear motors, the linear motors may be moving magnet type linear motors.

In addition, aerostatic bearings (not shown), for example, air bearings, which are provided to the lower surfaces of the stators 150, levitationally support the stators 150 above the base plate 12 with a prescribed clearance. Thereby, the reaction force generated by the movement of the wafer stages WST1, WST2, the Y coarse motion stages YC1, YC2, and the like in either one of the Y directions moves the stators 150, which serve as Y countermasses in the Y directions, in the other Y direction and is thereby offset by the law of conservation of momentum.

The Y coarse motion stage YC1 comprises X guides XG1 (i.e., guide members), which are provided between the sliders 151A, 151A and extend in the X directions, and is levitationally supported above the base plate 12 by a plurality of noncontact bearings, for example, air bearings 94, that is provided to a bottom surface of the Y coarse motion stage YC1.

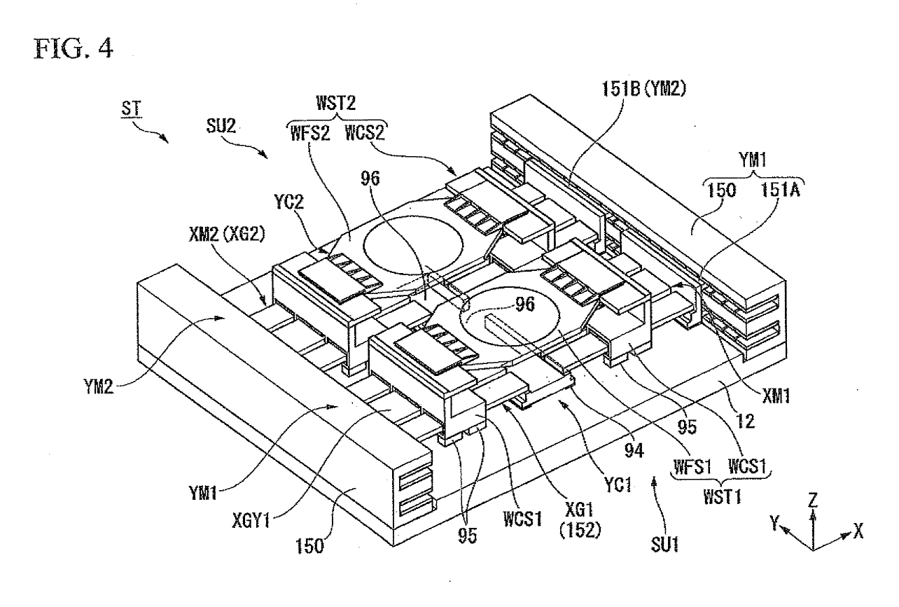

In addition, as shown in FIG. 4, a notch 96 that opens to the side that faces the drive shaft 134 and whose width is larger than the diameter of the drive shaft 134 discussed above is formed in the Y coarse motion stage YC1 at one side end part (i.e., the +Y side end part) of the center of the Y coarse motion stage YC1 in the longitudinal directions (i.e., the X axial directions). In greater detail, the notch 96 is formed along a relative motion pathway of the drive shaft 134 such that, even if the Y coarse motion stage YC1 is moved to a position at which the fine motion stage WFS1 is supported by the table main body 136, the notch 96 does not interfere with the drive shaft 134.

The X guides XG1 are provided with stators 152, which constitute the X motors XM1. As shown in FIG. 5, sliders 153A of the X motors XM1 are provided in through holes 154, wherethrough the X guides XG1 are inserted and that pass through the X coarse motion stages WCS1 in the X directions.

The two X coarse motion stages WCS1 are each levitationally supported above the base plate 12 by a plurality of noncontact bearings, for example, air bearings 95, provided to the bottom surfaces of the X coarse motion stages WCS1 and move in the X directions independently of one another along the X guides XG1 by the drive of the X motors XM1. The Y coarse motion stage YC1 is provided with, in addition to the X guides XG1, X guides XGY1 whereto the stators of the Y linear motors that drive the X coarse motion stage WCS1 in the Y directions are provided. Furthermore, in each of the X coarse motion stages WCS1, a slider 156A of the Y linear motor is provided in a through hole 155 (refer to FIG. 5), which passes through the X coarse motion stage WCS1 in the X directions. Furthermore, a configuration may be adopted wherein the X coarse motion stages WCS1 are supported in the Y directions by providing air bearings instead of providing the Y linear motors.

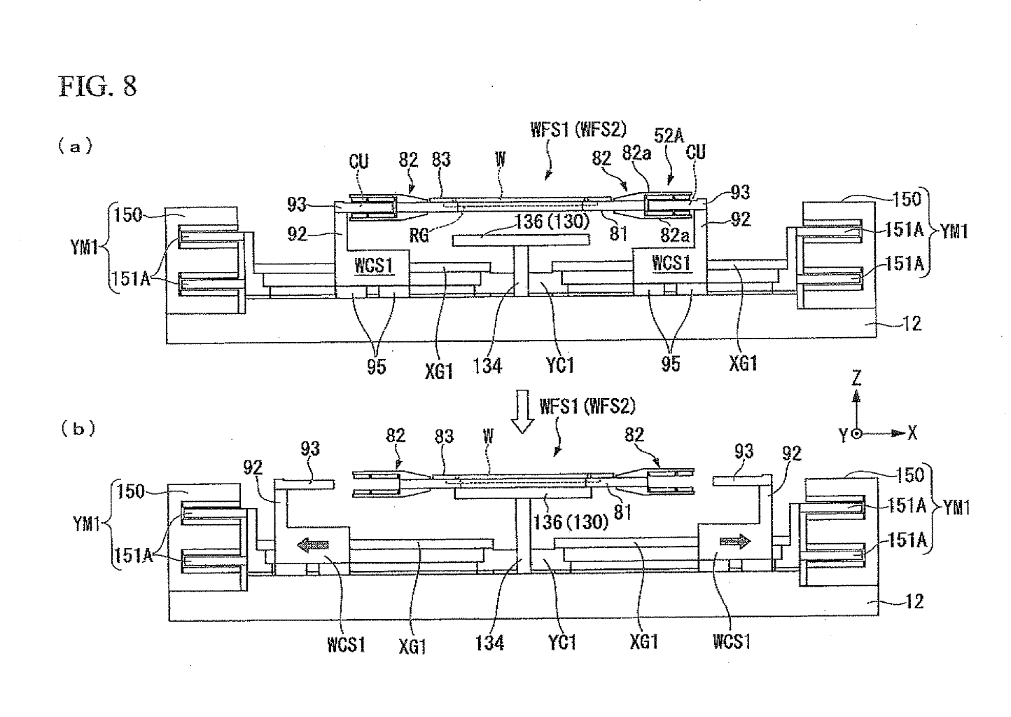

As shown in FIG. 5 and FIG. 8, a pair of sidewall parts 92 and a pair of stator parts 93, which are fixed to the upper surfaces of the sidewall parts 92, are provided to the outer side end parts in the X directions of the X coarse motion stages WCS1. As a whole, each of the coarse motion stages WCS1 has a box shape with a small height and that is open at the center part of the upper surface in the X axial directions and both side surfaces in the Y axial directions. Namely, a space is formed in each of the coarse motion stages WCS1 such that the space passes through the inner part of the coarse motion stages WCS1 in the Y axial directions.

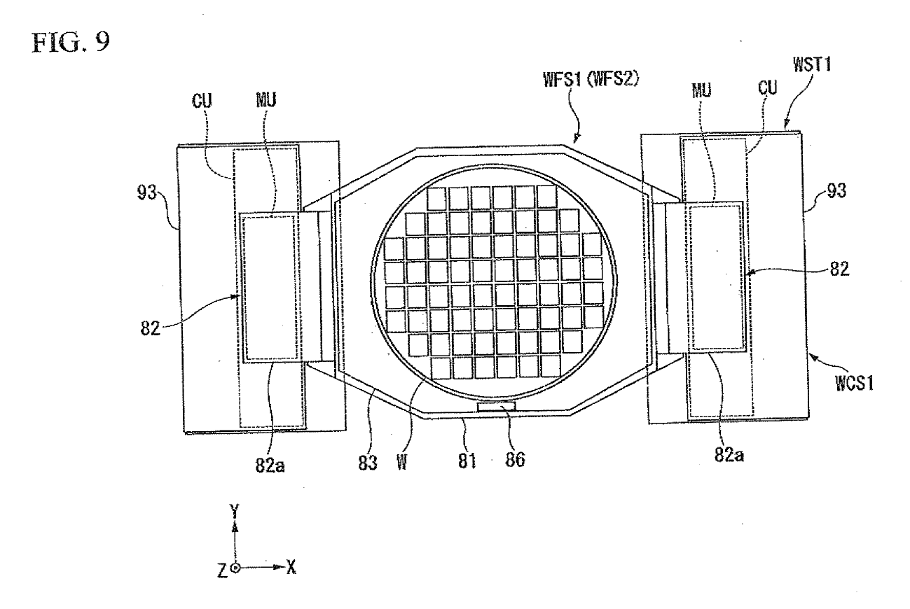

As shown in FIG. 5, FIG. 8, and FIG. 9, each stator part 93 of the pair of stator parts 93 comprises a plate shaped member whose outer shape is parallel to the XY plane; furthermore, each of the stator parts 93 houses a coil unit CU, which comprises a plurality of coils for driving the fine motion stage WFS1 (or WFS2). Here, the fine motion stage WFS1 and the fine motion stage WFS2 are identically configured and are similarly supported and driven noncontactually by the coarse motion stages WCS1; therefore, the text below explains the fine motion stage WFS1 only.

As shown in FIG. 8 and FIG. 9, the fine motion stage WFS1 comprises a main body part 81, which consists of an octagonal plate shaped member whose longitudinal directions are oriented in the X axial directions in a plan view, and two slider parts 82, which are fixed to one end part and the other end part of the main body part 81 in the longitudinal directions.

Because an encoder system measurement beam (i.e., laser light), which is discussed below, must be able to travel through the inner part of the main body part 81, the main body part 81 is formed from a transparent raw material wherethrough light can transmit. In addition, to reduce the effects of air turbulence on the laser light that passes through the inner part of the main body part 81, the main body part 81 is formed as a solid block (i.e., its interior has no space). Furthermore, although the entire main body part 81 may be formed from the transparent material, a configuration may be adopted wherein only the portion wherethrough the measurement beam of the encoder system transmits is formed from the transparent raw material; furthermore, a configuration may be adopted wherein only the latter is formed as a solid.

A wafer holder (not shown), which holds the wafer W by vacuum chucking or the like, is provided at the center of the upper surface of the main body part 81 of the fine motion stage WFS1. Furthermore, the wafer holder may be formed integrally with the fine motion stage WFS1 and may be fixed to the main body part 81 by bonding and the like or via, for example, an electrostatic chuck mechanism or a clamp mechanism.

Furthermore, as shown in FIG. 8 and FIG. 9, a circular opening whose circumference is larger than the wafer W (i.e., the wafer holder) is formed in the center of the upper surface of the main body part 81 on the outer side of the wafer holder (i.e., the mounting area of the wafer W), and a plate 83, whose octagonal outer shape (i.e., contour) corresponds to the main body part 81, is attached to the upper surface of the main body part 81. The front surface of the plate 83 is given liquid repellency treatment (i.e., a liquid repellent surface is formed) such that it is liquid repellent with respect to the liquid Lq. The plate 83 is fixed to the upper surface of the main body part 81 such that the entire front surface (or part of the front surface) of the plate 83 is coplanar with the front surface of the wafer W. In addition, as shown in FIG. 9, an oblong measuring plate 86 that is long and thin in the X axial directions is installed in the −Y side end part of the plate 83 such that the front surface of the measuring plate 86 is substantially coplanar with the front surface of the plate 83, namely, the front surface of the wafer W. At least a pair of the first fiducial marks discussed above and a second fiducial mark, which is detected by the primary alignment system AL1, are formed in the front surface of the measuring plate 86 (note that none of the first and second fiducial marks are shown).

As shown in FIG. 8, a two-dimensional grating RG (hereinbelow, simply called a “grating”) is disposed horizontally (i.e., parallel to the front surface of the wafer W) on the upper surface of the main body part 81 in an area whose circumference is larger than the wafer W. The grating RG comprises a reflective diffraction grating whose directions of periodicity are oriented in the X axial directions (i.e., an X diffraction grating) and a reflective diffraction grating whose directions of periodicity are oriented in the Y axial directions (i.e., a Y diffraction grating).

The upper surface of the grating RG is covered by a protective member, for example, a cover glass (not shown). In the present embodiment, the vacuum chucking mechanism (discussed above), which chucks the wafer holder, is provided to the upper surface of the cover glass, which is a holding surface. Furthermore, in the present embodiment, the cover glass is provided such that it covers substantially the entire surface of the upper surface of the main body part 81, but the cover glass may be provided such that it covers only the part of the upper surface of the main body part 81 that includes the grating RG. In addition, the protective member (i.e., the cover glass) may be formed from the same raw material as that of the main body part 81, but the present invention is not limited thereto; for example, the protective member may be formed from, for example, a metal or a ceramic material, or a configuration may be adopted wherein the protective member is formed as a thin film or the like.

As is clear from FIG. 8, the main body part 81 consists, as a whole, of an octagonal plate shaped member wherein overhanging parts that project from the outer sides of both end parts in the longitudinal directions are formed, and the center area wherein the grating RG is disposed is formed as a plate with a substantially uniform thickness.

Each of the slider parts 82 comprises plate shaped members 82a, which are positioned on both sides of the corresponding stator part 93 in the Z directions such that they sandwich the stator part 93, that are parallel to the XY plane. An end part of the stator part 93 of each of the coarse motion stages WCS1 is noncontactually inserted between the corresponding two plate shaped members 82a. In addition, each of the plate shaped members 82a houses a magnet unit MU, which is discussed below.

Here, as discussed above, both side surfaces of each of the coarse motion stages WCS1 in the Y axial directions are open; therefore, when the fine motion stage WFS1 is mounted to the coarse motion stages WCS1, the fine motion stage WFS1 should be positioned in the Z axial directions such that each of the stator parts 93 are positioned between the two corresponding plate shaped members 82a, 82a; subsequently, the fine motion stage WFS1 should be moved (i.e., slid) in the Y axial directions.

Bach of the fine motion stage drive systems 52A comprises a pair of the magnet units MU, which is provided to the corresponding slider part 82 discussed above, and a coil unit CU, which is provided to the corresponding stator part 93.

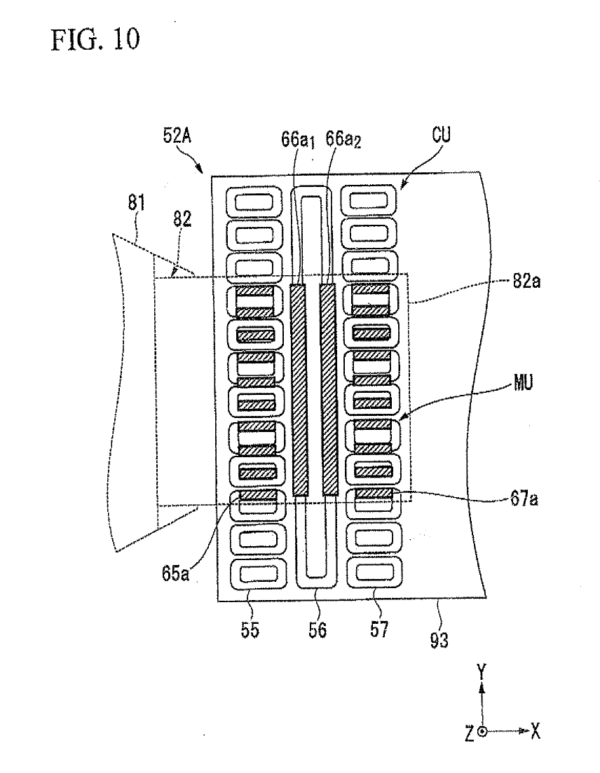

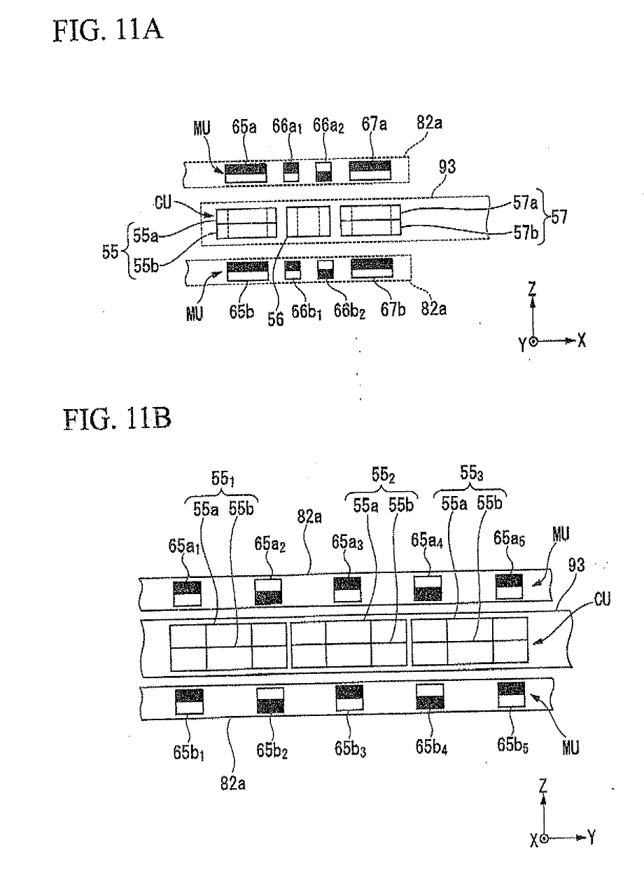

This will now be discussed in further detail. As shown in FIG. 10, FIG. 11A and FIG. 11B, a plurality of YZ coils 55 (herein, 12) and a plurality of YZ coils 57 (herein, 12) (hereinbelow, these are abbreviated as “coils” where appropriate), which are oblong in a plan view, are disposed as a two-column coil array, wherein the columns are disposed equispaced in the Y axial directions, such that the coils are spaced apart by a prescribed spacing in the X axial directions; furthermore, the YZ coils 55, 57 are disposed on the −X side end part inside the corresponding stator part 93. Each of the YZ coils 55 comprises an upper part winding 55a and a lower part winding 55b, which are oblong in a plan view and disposed such that they overlap in the vertical directions (i.e., the Z axial directions). In addition, one X coil 56 (hereinbelow, abbreviated as “coil” where appropriate), which in a plan view is a long, thin oblong whose longitudinal directions are oriented in the Y axial directions, is disposed inside the corresponding stator part 93 and between the columns of the two-column coil array discussed above. In this case, each of the columns of the two-column coil array and the X coil 56 are disposed equispaced in the X axial directions. Together, the two-column coil array and the X coil 56 constitute the coil unit CU.

Furthermore, the following text explains one of the stator parts 93 of the pair of stator parts 93 and the corresponding slider part 82 that is supported by that stator part 93; however, the other (i.e., the −X side) stator part 93 and slider part 82 are identically configured and function the same way.

A plurality of permanent magnets 65a, 67a (herein, 10 of each), which are oblong in a plan view and whose longitudinal directions are oriented in the X axial directions, are disposed equispaced in the Y axial directions inside the +Z side plate shaped member 82a, which constitutes past of the corresponding slider part 82 of the fine motion stage WFS1, thereby constituting a two-column magnet array. The columns of the two-column magnet array are disposed spaced apart by a prescribed spacing in the X axial directions. In addition, the columns of the two-column magnet array are disposed such that they oppose the coils 55, 57.

As shown in FIG. 11B, the plurality of the permanent magnets 65a is arrayed such that permanent magnets whose upper surface side (i.e., +Z side) is its N-pole and whose lower surface side (i.e., −Z side) is its S-pole and permanent magnets whose upper surface side (i.e., +Z side) is its S-pole and whose lower surface side (i.e., −Z side) is its N-pole alternate in the Y axial directions. The magnet column that comprises the plurality of the permanent magnets 67a is configured identically to the magnet column that comprises the plurality of the permanent magnets 65a.

In addition, two permanent magnets 66a1, 66a2, which are disposed spaced apart in the X axial directions and whose longitudinal directions are oriented in the Y axial directions, are disposed inside the plate shaped member 82a between the columns of the two-column magnet array discussed above such that they oppose the coil 56. As shown in FIG. 11A, the permanent magnet 66a1 is configured such that its upper surface side (i.e., its +Z side) is its N-pole and its lower surface side (i.e., −Z side) is its S-pole; furthermore, the permanent magnet 66a2 is configured such that its upper surface side (i.e., +Z side) is its S-pole and its lower surface side (i.e., −Z side) is its N-pole.

The plurality of the permanent magnets 65a, 67a and 66a1, 66a2 discussed above constitutes one of the magnet units MU.

As shown in FIG. 11A, permanent magnets 65b, 66b1, 66b2, 67b similarly are disposed inside the −Z side plate shaped member 82a with the same arrangement as in the +Z side plate shaped member 82a discussed above. These permanent magnets 65b, 66b1, 66b2, 67b constitute the other magnet unit MU. Furthermore, the permanent magnets 65b, 66b1, 66b2, 67b inside the −Z side plate shaped member 82a are disposed moll that they overlap the magnets 65a, 66a1, 66a2, 67a on the paper plane far side in FIG. 10.

Here, as shown in FIG. 11B, in the fine motion stage drive system 52A, the positional relationships (i.e., the individual spacings) in the Y axial directions between the plurality of permanent magnets 65a and the plurality of YZ coils 55 are set such that, with regard to the plurality of permanent magnets disposed adjacently in the Y axial directions (i.e., permanent magnets 65a1-65a5 arranged in linear order in the Y axial directions), when the two adjacent permanent magnets 65a1 and 65a2 each oppose a winding part of a YZ coil 55₁, the adjacent permanent magnet 65a3 does not oppose a winding part of a YZ coil 55₂, which is adjacent to the YZ coil 55₁ discussed above (i.e., such that it opposes either the hollow at the center of the coil or the core around which the coil is wound, e.g., the iron core). Furthermore, each of the permanent magnets 65a4 and 65a5 opposes a winding part of a YZ coil 55₃, which is adjacent to the YZ coil 55₂. The spacings between the permanent magnets 65b, 67a, 67b in the Y axial directions are all the same (refer to FIG. 11B).

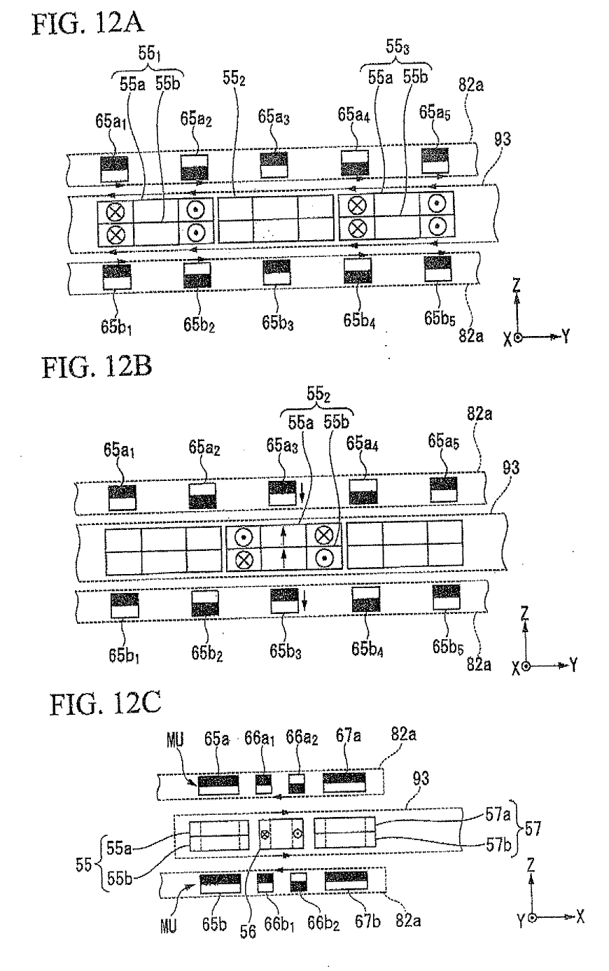

Accordingly, in the fine motion stage drive system 52A, as shown in FIG. 12A and in the state shown in FIG. 11B as an example, if clockwise currents, viewed from the +Z direction, are supplied to each upper part winding and lower part winding of the coils 55₁, 55₃, then forces (i.e., Lorentz's forces) in the −Y direction will act on the coils 55₁, 55₃ and in reaction thereto, forces in the +Y direction will act on the permanent magnets 65a, 65b. These forces act to move the fine motion stage WFS1 in the +Y direction with respect to the coarse motion stage WCS1. If, on the other hand, counterclockwise currents, viewed from the +Z direction, are supplied to each of the coils 55₁, 55₃, then the fine motion stage WFS1 moves in the −Y direction with respect to the coarse motion stage WCS1.

Supplying electric currents to the coils 57 induces an electromagnetic interaction between the permanent magnets 67 (67a, 67b), which makes it possible to drive the fine motion stage WFS1 in the Y axial directions. The main control apparatus 20 controls the position of the fine motion stage WFS1 in the Y axial directions by controlling the electric current supplied to each of the coils.

In addition, in the fine motion stage drive system 52A, as shown in FIG. 12B and in the exemplary state shown in FIG. 11B, if a counterclockwise current, viewed from the +Z direction, is supplied to the upper part winding of the coil 55₂ and a clockwise current, viewed from the +Z direction, is supplied to the lower part winding of the coil 55₂, then an attraction force is generated between the coil 55₂ and the permanent magnet 65a3 and a repulsion force is generated between the coil 55₁ and a permanent magnet 65b3; furthermore, these attraction and repulsion forces move the fine motion stage WFS1 upward (i.e., in the +Z direction) with respect to the coarse motion stage WCS1, namely, the forces levitate the fine motion stage WFS1. The main control apparatus 20 controls the position of the fine motion stage WFS1 in the Z axial directions in the levitated stale by controlling the electric currents supplied to each of the coils.

In addition, as shown in FIG. 12C and in the state shown in FIG. 11A, if a clockwise current, viewed from the +Z direction, is supplied to the coil 56, then a force in the +X direction acts on the coil 56 and, in reaction thereto, forces in the −X direction act on each of the permanent magnets 66a1, 66a2 and 66b1, 66b2, which moves the fine motion stage WFS1 in the −X direction with respect to the coarse motion stage WCS1. In addition, if, on the other hand, a counterclockwise current, viewed from the +Z direction, is supplied to the coil 56, then forces in the +X direction act on the permanent magnets 66a1, 66a2 and 66b1, 66b2, which moves the fine motion stage WFS1 in the +X direction with respect to the coarse motion stage WCS1. The main control apparatus 20 controls the position of the fine motion stage WFS1 in the X axial directions by controlling the electric currents supplied to each of the coils.

As is clear from the explanation above, in the present embodiment, the main control apparatus 20 drives the fine motion stage WFS1 in the Y axial directions by supplying an electric current to every other coil of the plurality of the YZ coils 55, 57 arrayed in the Y axial directions. In addition, in parallel therewith, the main control apparatus 20 levitates the fine motion stage WFS1 above the coarse motion stage WCS1 by generating driving forces in the Z axial directions that are separate from the driving forces in the Y axial directions by supplying electric currents to coils of the YZ coils 55, 57 that are not used to drive the fine motion stage WFS1 in the Y axial directions. Furthermore, by sequentially switching, in accordance with the position of the fine motion stage WFS1 in the Y axial directions, which of the coils are supplied with electric current, the main control apparatus 20 drives the fine motion stage WFS1 in the Y axial directions while maintaining the state wherein the fine motion stage WFS1 is levitated above the coarse motion stage WCS1, namely, a noncontactual state. In addition, in the state wherein the fine motion stage WFS1 is levitated above the coarse motion stage WCS1, the main control apparatus 20 can also drive the fine motion stage WFS1 independently in the X axial directions in addition to the Y axial directions.

In addition, the main control apparatus 20 can rotate the fine motion stage WFS1 around the Z axis (i.e., can perform θz rotation) by causing driving forces (i.e., thrusts) of different magnitudes in the Y axial directions to act on the +X side slider part 82 and the −X side slider part 82 of the, fine motion stage WFS1.

Likewise, the main control apparatus 20 can rotate a fine motion stage WFS1 around the Y axis (i.e., can perform θy drive to rotation) by causing levitational forces of different magnitudes to act on the +X side slider part 82 and the −X side slider part 82 of the fine motion stage WFS1.

Furthermore, the main control apparatus 20 can rotate the fine motion stage WFS1 around the X axis (i.e., can perform θx drive to rotation) by causing levitational forces of different magnitudes to act on the plus side and the minus side in the Y axial directions of each of the slider parts 82 of the fine motion stage WFS1.

As is clear from the explanation above, in the present embodiment, the fine motion stage drive system 52A can levitationally support the fine motion stage WFS1 in a noncontactual state above the coarse motion stage WCS1 and can drive the coarse motion stage WCS1 noncontactually in directions (X, Y, Z, θx, θy, and θz) corresponding to six degrees of freedom.

In the exposure apparatus 100 of the present embodiment, when a step-and-scan type exposure operation is being performed on the wafer W, the main control apparatus 20 uses an encoder system 73 (refer to FIG. 6) of the fine motion stage position measuring system 70A (discussed below) to measure the position within the XY plane (including the position in the θz directions) of the fine motion stage WFS1. The positional information of the fine motion stage WFS1 is sent to the main control apparatus 20, which, based thereon, controls the position of the fine motion stage WFS1.

In contrast, when the wafer stage WST1 (i.e., the fine motion stage WFS1) is positioned outside of the measurement area of the fine motion stage position measuring system 70A, the main control apparatus 20 uses the wafer stage position measuring system 16A (refer to FIG. 1 and FIG. 6) to measure the position of the wafer stage WST1 (and the fine motion stage WFS1). As shown in FIG. 1, the wafer stage position measuring system 16A comprises laser interferometers, which radiate length measuring beams to reflective surfaces on the side surfaces of the coarse motion stages WCS1 and measure the position within the XY plane (including the rotation in the θz directions) of the wafer stage WST1. Furthermore, instead of using the wafer stage position measuring system 16A discussed above to measure the position within the XY plane of the wafer stage WST1, some other measuring apparatus, for example, an encoder system, may be used. In such a case, for example, a two dimensional scale can be disposed on the upper surface of the base plate 12, and an encoder head can be provided to each of the bottom surfaces of the coarse motion stages WCS1.

The fine motion stage WFS2 is configured identically to the fine motion stage WFS1 discussed above; furthermore, the coarse motion stages WCS1 can noncontactually support the fine motion stage WFS2 instead of the fine motion stage WFS1. In such a case, the wafer stage WST1 would comprise the coarse motion stages WCS1 and the fine motion stage WFS2 supported by the coarse motion stages WCS1, and the fine motion stage drive system 52A would comprise the pairs of slider parts (i.e., the pairs of magnet units MU) provided by the fine motion stage WFS2 and the pair of stator parts 93 (i.e., the coil units CU) of the coarse motion stages WCS1. Furthermore, the fine motion stage drive system 52A would drive the fine motion stage WFS2 noncontactually with respect to the coarse motion stages WCS1 in the directions corresponding to six degrees of freedom.

In addition, each of the fine motion stages WFS2, WFS1 can be supported noncontactually by the coarse motion stages WCS2; furthermore, the wafer stage WST2 comprises the coarse motion stages WCS2 and the fine motion stage WFS2 or WFS1 supported by the coarse motion stages WCS2. In this case, a fine motion stage drive system 52B (refer to FIG. 6) would comprise the pairs of slider parts (i.e., the pairs of magnet units MU) provided by the fine motion stage WFS2 or WFS1 and the pair of stator parts 93 (i.e., the coil units CU) of the coarse motion stages WCS2. Furthermore, the fine motion stage drive system 52B would drive the fine motion stage WFS2 or WFS1 noncontactually with respect to the coarse motion stages WCS2 in the directions corresponding to six degrees of freedom.

Furthermore, the coarse motion stages WCS2 are disposed on the base plate 12 in an orientation that is the opposite of that of the coarse motion, stages WCS1, namely, the notch 96 of the Y coarse motion stage YC2 is oriented such that it opens toward the other side (i.e., the −Y side) of the Y axial directions.

The following text explains the configuration of the fine motion stage position measuring system 70A (refer to FIG. 6), which is used to measure the position of the fine motion stage WFS1 or WFS2 (which constitutes the wafer stage WST1) held moveably by the coarse motion stages WCS1 in the exposure station 200. Here, the case wherein the fine motion stage position measuring system 70A measures the position of the fine motion stage WFS1 will be explained.

As shown in FIG. 1, the fine motion stage position measuring system 70A comprises the measuring arm 71A, which is inserted in the space inside each of the coarse motion stages WCS1 in the state wherein the wafer stage WST1 is disposed below the projection optical system PL. The measuring arm 71A is supported in a cantilevered state by the main frame BD via the support member 72A (i.e., the vicinity of one-end part is supported).

The measuring arm 71A is a square columnar shaped member (i.e., a rectangular parallelepipedic member) whose longitudinal directions are oriented in the Y axial directions and whose longitudinal oblong cross section is such that the size in the height directions (i.e., the Z axial directions) is greater than the size in the width directions (i.e., the X axial directions); furthermore, the measuring arm 71A is formed from the identical raw material wherethrough, the light transmits, for example, by laminating a plurality of glass members together. The measuring arm 71A is formed as a solid, excepting the portion wherein the encoder head (i.e., the optical system) is housed (discussed below). As discussed above, a tip part of the measuring arm 71A is inserted in the spaces of the coarse motion stages WCS1 in the state wherein the wafer stage WST1 is disposed below the projection optical system PL; furthermore, as shown in FIG. 1, the upper surface of the measuring arm 71A opposes the lower surface of the fine motion stage WFS1 (more accurately, the lower surface of the main body part 81; not shown in FIG. 1; refer to FIG. 8 and the like). The upper surface of the measuring arm 71A is disposed substantially parallel to the lower surface of the fine motion stage WFS1 in the state wherein a prescribed clearance, for example, approximately several millimeters, is formed between the upper surface of the measuring arm 71A and the lower surface of the fine motion stage WFS1.

As shown in FIG. 6, the fine motion stage position measuring system 70A comprises the encoder system 73 and a laser interferometer system 75. The encoder system 73 comprises an X linear encoder 73x, which measures the position of the fine motion stage WFS1 in the X axial directions, and a pair of Y linear encoders 73ya, 73yb, which measures the position of the fine motion stage WFS1 in the Y axial directions. The encoder system 73 uses diffraction interference type heads with a configuration identical to that of the encoder head (herein below, abbreviated as “head” where appropriate) disclosed in, for example, U.S. Pat. No. 7,238,931 and U.S. Patent Application Publication No. 2007/288,121. However, in the head of the present embodiment, the light source and a light receiving system (including a photodetector) are disposed outside of the measuring arm 71A (as discussed below), and only the optical system is disposed inside the measuring arm 71A, namely, opposing the grating RG. Herein below, the optical system disposed inside the measuring arm 71A is called a head where appropriate.

The encoder system 73 measures the position of, for example, the fine motion stage WFS1 in the X axial directions with one X head and in the Y axial directions with a pair of Y heads. Namely, the X linear encoder 73x (discussed above) comprises the X head that uses the X diffraction grating of the grating RG to measure the position of the fine motion stage WFS1 in the X axial directions, and the pair of Y linear encoders 73ya, 73yb comprises the pair of Y heads that uses the Y diffraction grating of the grating RG to measure the position of the fine motion stage WFS1 in the Y axial directions.

Furthermore, because the encoder system 73 is described in detail in Japanese Patent Application No. 2009-122361 and the like, the explanation thereof is omitted herein.

The main control apparatus 20 determines the position of the fine motion stage WFS1 in the Y axial directions and the X axial directions based on the measurement results of the encoder system 73. Namely, in the present embodiment, the main control apparatus 20 uses the encoder system 73 to continuously measure—directly below the exposure position (i.e., on the rear surface side of the fine motion stage WFS1)—the position of the fine motion stage WFS1 within the XY plane when the pattern of the reticle R is transferred to a prescribed shot region on the wafer W mounted on the fine motion stage WFS1. In addition, the main control apparatus 20 measures the amount of rotation of the fine motion stage WFS1 in the θz directions based on the difference in the measurement values of the two Y heads.

The laser interferometer system 75 causes three length measuring beams to emerge from the tip part of the measuring arm 71A and impinge the lower surface of the fine motion stage WFS1. The laser interferometer system 75 comprises three laser interferometers 75a-75c (refer to FIG. 6), each of which radiates one of these three length measuring beams. In the laser interferometer system 75, the three length measuring beams are emitted parallel to the Z axis. The center of gravity of the triangle formed by the positions at which the three length, measuring beams emerge within the XY plane is disposed such that it coincides with the exposure position, which is the center of the irradiation area IA (i.e., the exposure area). In the present embodiment, the main control apparatus 20 uses the laser interferometer system 75 to measure the position in the Z axial directions and the amounts of rotation in the θz and θy directions of the fine motion stage WFS1.

Furthermore, because the laser interferometer system 75 also is described in detail in Japanese Patent Application No. 2009422361 and the like, the explanation thereof is omitted herein.

As can be understood from the explanation above, using the encoder system 73 of the fine motion stage position measuring system 70A and the laser interferometer system 75, the main control apparatus 20 can measure the position of the fine motion stage WFS1 in directions corresponding to six degrees of freedom. In this case, in the encoder system 73, the in-air optical path lengths of the measurement beams are extremely short and substantially equal, and consequently the effects of air turbulence are virtually inconsequential. Accordingly, the encoder system 73 can measure, with high accuracy, the position of the fine motion stage WFS1 within the XY plane (including the θz directions). In addition, because the detection point of the encoder system 73 on the grating RG in the X axial directions and in the Y axial, directions and the detection point of the laser interferometer system 75 on the lower surface of the fine motion stage WFS1 in the Z axial directions substantially coincide with the center (i.e., the exposure position) of the exposure area IA, so-called Abbé error is suppressed to such a degree that it is substantially inconsequential. Accordingly, using the fine motion stage position measuring system 70A, the main control apparatus 20 can measure, with high accuracy, the position of the fine motion stage WFS1 in the X axial directions, the Y axial directions, and the Z axial directions without Abbé error. In addition, if the coarse motion stages WCS1 are disposed below the projection unit PU and the fine motion stage WFS2 is moveably supported by the coarse motion stages WCS1, then, using the fine motion stage position measuring system 70A, the main control apparatus 20 can measure the position of the fine motion stage WFS2 in the directions corresponding to six degrees of freedom; in particular, the main control apparatus 20 can measure, with high accuracy and without Abbé error, the position of the fine motion stage WFS2 in the X axial directions, the Y axial directions, and the Z axial directions.

In addition, as shown in FIG. 1, the fine motion stage position measuring system 70B, which is provided to the measurement station 300, is bilaterally symmetric with and identically configured to the fine motion stage position measuring system 70A. Accordingly, the measuring arm 71B, which is provided to the fine motion stage position measuring system 70B, is oriented such that its longitudinal directions are in the Y axial directions; furthermore, the vicinity of the +Y side end part of the measuring arm 71B is supported such that it is substantially cantilevered from the main frame BD via the support member 72B.

If the coarse motion stages WCS2 are disposed below the alignment apparatus 99 and the fine motion stage WFS2 or WFS1 is moveably supported by the coarse motion stages WCS2, then, using the fine motion stage position measuring system 70B, the main control apparatus 20 can measure the position of the fine motion stage WFS2 or WFS1 in the directions corresponding to six degrees of freedom; in particular, the main control apparatus 20 can measure, with high accuracy and without Abbé error, the position of the fine motion stage WFS2 or WFS1 in the X axial directions, the Y axial directions, and the Z axial directions.

FIG. 6 shows the principal components of the control system of the exposure apparatus 100. The heart of the control system is the main control apparatus 20. The main control apparatus 20 is, for example, a workstation (or a microcomputer) that supervisorally controls each constituent part of the exposure apparatus 100 including the local liquid immersion apparatus 8, coarse motion stage drive systems 51A, 51B, and the fine motion stage drive systems 52A, 52B, which are discussed above.

When a device is fabricated using the exposure apparatus 100 of the present embodiment, the pattern of the reticle R is transferred to each shot region of the plurality of shot regions on the wafer W by performing a step-and-scan type exposure on the wafer W, which is held by one of the fine motion stages (here, the WFS1 as an example) held by the coarse motion stages WCS1 in the exposure station 200. In the step-and-scan type exposure operation, the main control apparatus 20 repetitively performs an inter-shot movement operation, wherein the fine motion stage WFS1 is moved to a scanning start position (i.e., an acceleration start position) in order to expose each of the shot regions on the wafer W, and a scanning exposure operation, wherein the pattern formed on the reticle R is transferred to each of the shot regions by a scanning exposure, based on, for example, the result of the wafer alignment (e.g., the information obtained by converting the array coordinates of each shot region on the wafer W obtained by enhanced global alignment (EGA) to coordinates wherein the second fiducial mark serves as a reference) and the result of the reticle alignment, both alignments being performed in advance. Furthermore, the abovementioned exposure operation is performed in the state wherein the liquid Lq is held between the tip lens 191 and the wafer W, namely, the abovementioned exposure operation is performed by an immersion exposure. In addition, the operation is performed in order starting with the shot regions positioned on the +Y side and ending with the shot regions positioned on the −Y side. Furthermore, EGA is disclosed in detail in, for example, U.S. Pat. No. 4,780,617.

In the exposure apparatus 100 of the present embodiment, during the sequence of exposure operations discussed above, the main control apparatus 20 uses the fine motion stage position measuring system 70A to measure the position of the fine motion stage WFS1 (i.e., the wafer W) and, based on this measurement result, controls the position of the wafer W.

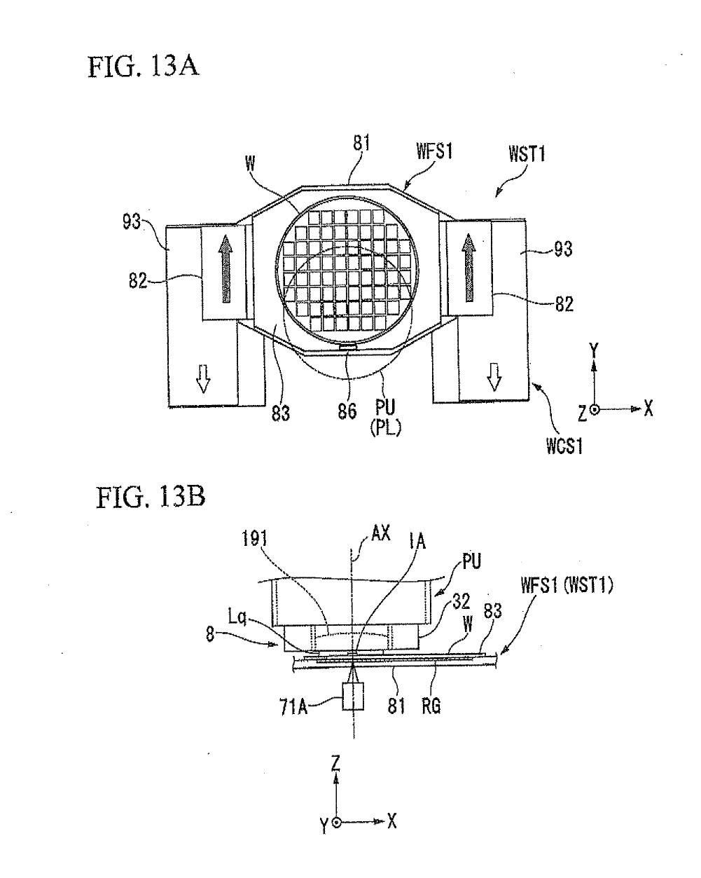

Furthermore, during the scatting exposure operation discussed above, the wafer W must he driven in the Y axial directions at a high acceleration; however, in the exposure apparatus 100 of the present embodiment, as shown in FIG. 13A, the main control apparatus 20 scans the wafer W in the Y axial directions by driving only the fine motion stage WFS1 in the Y axial directions (refer to the filled arrows in FIG. 13A; and, as needed, in the directions corresponding to the other five degrees of freedom) without, as a rule, driving the coarse motion stages WCS1. This is because to drive the wafer W at high acceleration, it is advantageous to drive the wafer W using only the fine motion stage WFS1, which is lighter than the coarse motion stages WCS1. In addition, as discussed above, the position measurement accuracy of the fine motion stage position measuring system 70A is higher than that of the wafer stage position measuring system 16A, and therefore it is advantageous to drive the fine motion stage WFS1 during the scanning exposure.

Furthermore, the Y coarse motion stage YC1 is not shown in FIG. 13A and FIG. 13B and in subsequent drawings is shown only where appropriate.

Moreover, when the inter-shot movement operation (i.e., stepping) is performed in the X axial directions, the fine motion stage WFS1 can move in the X axial directions by only a small amount; therefore, as shown in FIG: 13A, the main control apparatus 20 moves the wafer W in the X axial directions by integrally driving the pair of X coarse motion stages WCS1 in the X axial directions.

In the present embodiment, while one of the wafers W is being exposed on one of the fine motion stages as discussed above, another is being at least partly exchanged or aligned on the other fine motion stage in parallel with the exposure.

### (Parallel Process Operations)

The following text explains the parallel process operations performed using the two fine motion stages WFS1, WFS2 in the exposure apparatus 100 of the present embodiment.

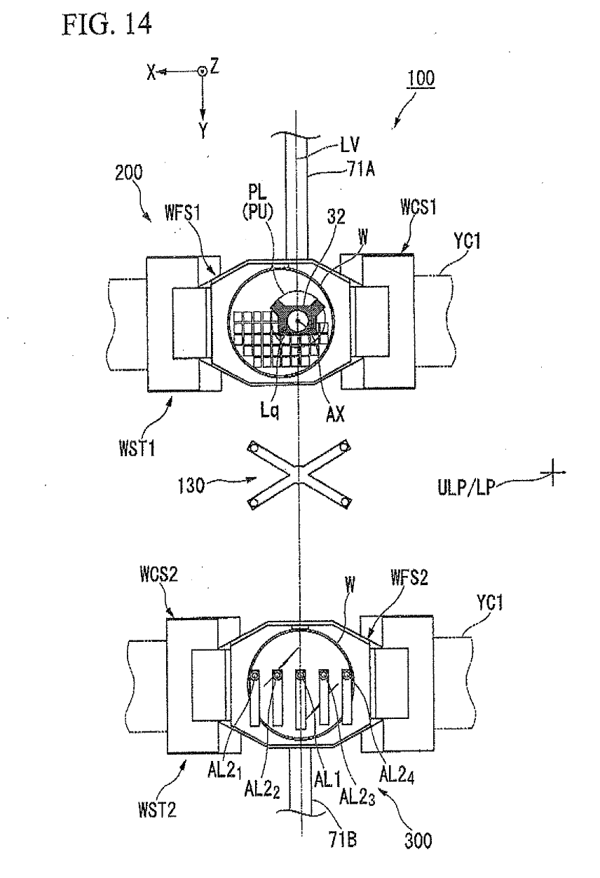

FIG. 14 shows a state wherein the fine motion stage WFS1 is at the exposure station 200 and the exposure discussed above is being performed on one of the wafers W, which is held by the fine motion stage WFS1; furthermore, the fine motion stage WFS2 is at the measurement station 300 where an alignment process is being performed on another wafer W, which is held by the fine motion stage WFS2, prior to the exposing process.

The following text briefly describes the alignment of the wafer W held by the fine motion stage WFS2. Namely, when a wafer alignment is performed, the main control apparatus 20 first drives the fine motion stage WFS2 to position the measuring plate 86 mounted on the fine motion stage WFS2 directly below the primary alignment system AL1, which the main control apparatus 20 uses to detect the second fiducial mark. Furthermore, as disclosed in for example, U.S. Patent Application Publication No. 2008/0088843, the main control apparatus 20 moves the wafer stage WST2 (i.e., the coarse motion stages WCS2 and the fine motion stage WFS2) in, for example, the −Y direction and positions the wafer stage WST2 at a plurality of locations along the travel path; furthermore, with each positioning, the main control apparatus 20 uses at least one of the alignment systems AL1, AL2₁-AL2₄ to detect the position of an alignment mark in the alignment shot region (i.e., the sample shot region). Let us consider a case involving, for example, four positionings: during the first positioning, for example, the main control apparatus 20 uses the primary alignment system AL1 and the secondary alignment systems AL2₂, AL2₃ to detect the alignment marks (hereinbelow, also called sample marks) in three sample shot regions; during the second positioning, the main control apparatus 20 uses the alignment systems AL1, AL2₁-AL2₄ to detect five sample marks on the wafer W; during the third positioning, the main control apparatus 20 uses the alignment systems AL1, AL2₁-AL2₄ to detect five sample marks; and during the fourth positioning, the main control apparatus 20 uses the primary alignment system AL1 and the secondary alignment systems AL2₂, AL2₃ to detect three sample marks. Thereby, the positions of the alignment marks in a total of 16 alignment shot regions can be obtained in a markedly shorter time than in the case wherein a single alignment system sequentially detects the 16 alignment marks. In this case, the alignment systems AL1, AL2₂, AL2₃ detect—in conjunction with the abovementioned operation of moving the wafer stage WST2—the plurality of alignment marks (i.e., sample marks) arrayed along the Y axial directions and sequentially disposed within the detection areas (e.g., corresponding to the areas irradiated by the detection beams). Consequently, when the abovementioned alignment marks are measured, it is not necessary to move the wafer stage WST2 in the X directions.

In the present embodiment, when performing the wafer alignment, including the detection of the second fiducial mark, the main control apparatus 20 uses the fine motion stage position measuring system 70B, including the measuring arm 71B, to measure the position within the XY plane of the fine motion stage WFS2 supported by the coarse motion stages WCS2 during the wafer alignment. However, the present invention is not limited thereto; for example, if the fine motion stage WFS2 is moved integrally with the coarse motion stages WCS2 during the wafer alignment, then the wafer alignment may be performed while measuring the position of the wafer W via the wafer stage position measuring system 16B as discussed above. In addition, because the measurement station 300 and the exposure station 200 are spaced apart, the position of the fine motion stage WFS2 during the wafer alignment and during the exposure is controlled using different coordinate systems. Accordingly, the main control apparatus 20 converts the array coordinates of each of the shot regions on the wafer W, which were obtained as a result of the wafer alignment, to array coordinates wherein the second fiducial mark serves as a reference.

In so doing, the wafer alignment of the wafer W held by the fine motion stage WFS2 is complete.

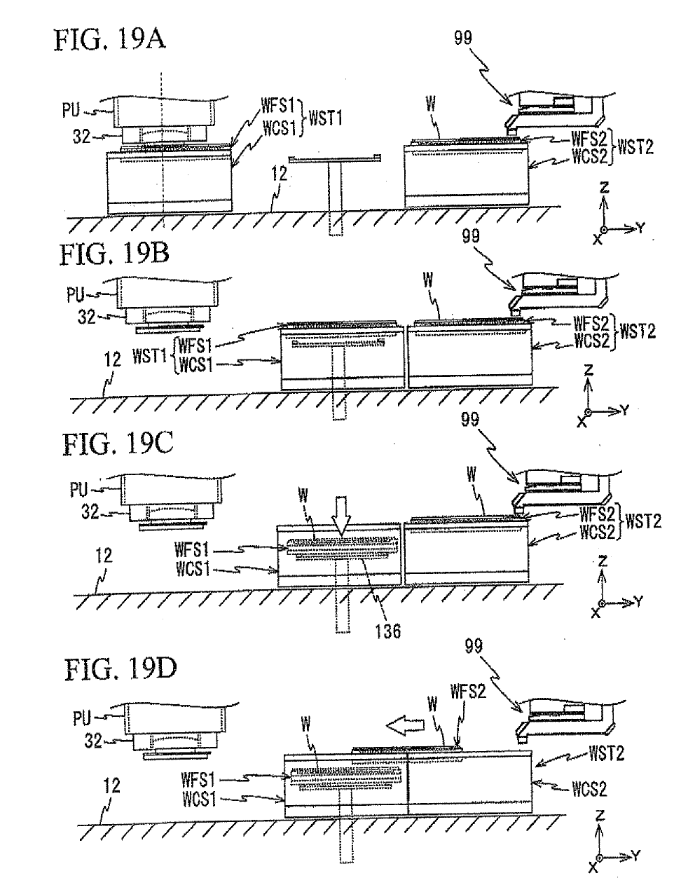

FIG. 19A schematically shows the positional relationship between the coarse motion stage WCS1 and the coarse motion stage WCS2 at the point at which the alignment of the wafer W is complete.

In the state wherein the wafer stage WST2 is placed on standby at the position shown in FIG. 19A, the main control apparatus 20 waits for the exposure of the wafer W on the fine motion stage WFS1 to end.

FIG. 16 shows the state of the wafer stage WST1 immediately after the exposure has ended.

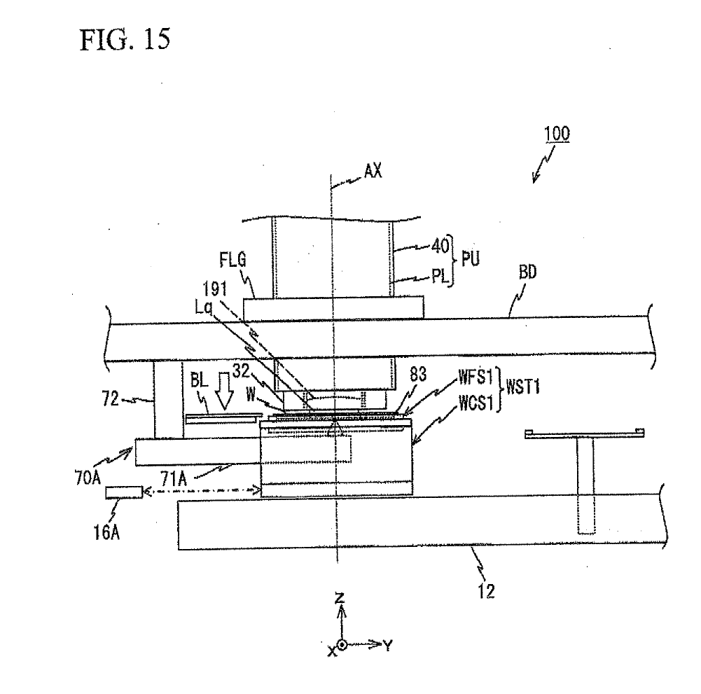

Prior to the completion of the exposure, as shown by the outlined arrow in FIG. 15, the main control apparatus 20 uses the blade drive system 58 to drive the movable blade BL downward by a prescribed amount from the state shown in FIG. 7. Thereby, as shown in FIG. 15, the upper surface of the movable blade BL and the upper surface of the fine motion stage WFS1 (and the wafer W), which is positioned below the projection optical system PL, are coplanar. Furthermore, the main control apparatus 20 waits in this state for the exposure to end.

Furthermore, when the exposure is complete, the main control apparatus 20 uses the blade drive system 58 to drive the movable blade BL by a prescribed amount in the +Y direction (refer to the outlined arrow in FIG. 16), and the movable blade BL is either brought into contact with the fine motion stage WFS1 or made proximate therewith with a clearance of approximately 300 μm. Namely, the main control apparatus 20 sets the movable blade BL and the fine motion stage WFS1 to a “scrum” state.

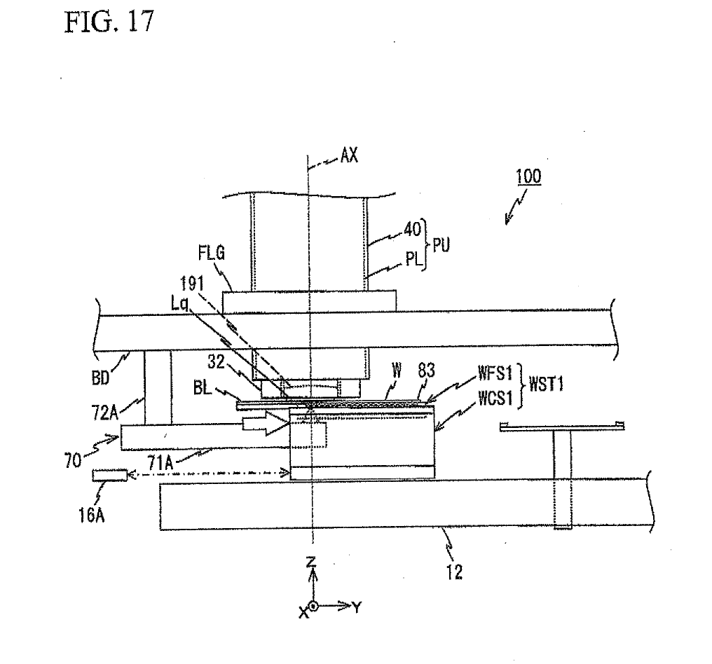

Next, as shown in FIG. 17, the main control apparatus 20 drives the movable blade BL integrally with the wafer stage WST1 in the +Y direction (refer to the outlined arrow in FIG. 17) while maintaining the “scrum” state between the movable blade BL and the fine motion stage WFS1. Thereby, the immersion space formed by the liquid Lq and held between the fine motion stage WFS1 and the tip lens 191 is transferred from the fine motion stage WFS1 to the movable blade BL. FIG. 17 shows the state immediately before the immersion space formed by the liquid Lq is transferred from the fine motion stage WFS1 to the movable blade BL. In this state, the liquid Lq is held between the tip lens 191 on one side and the fine motion stage WFS1 and the movable blade BL on the other side.

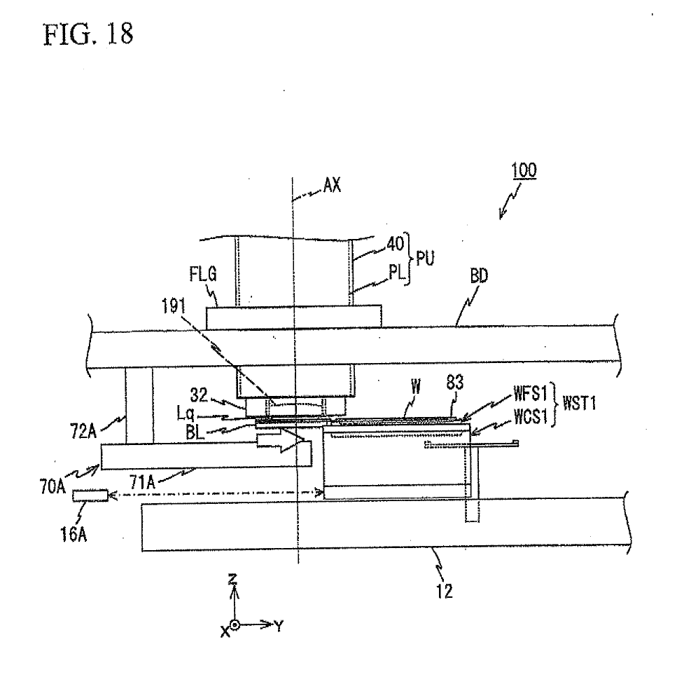

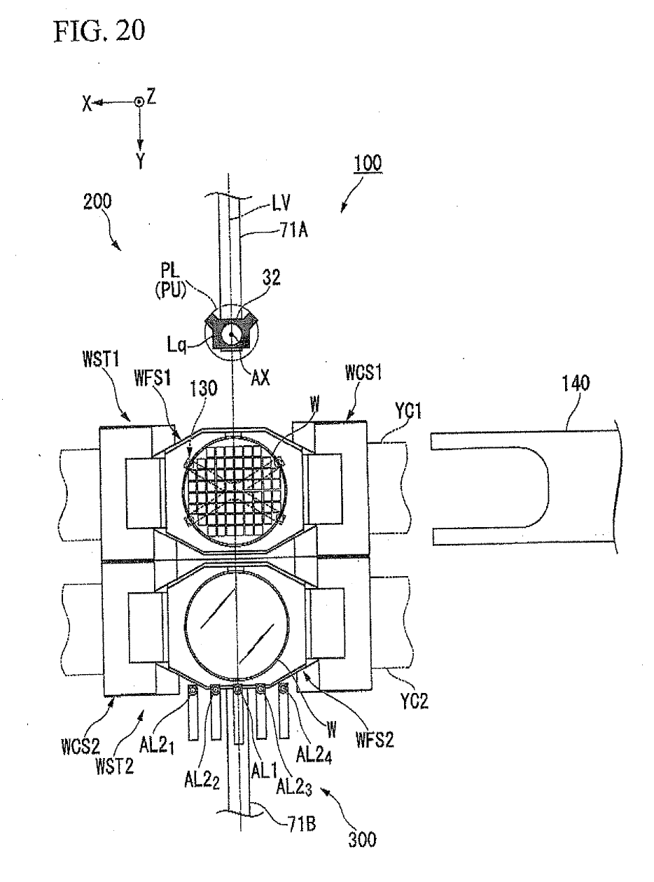

Furthermore, as shown in FIG. 18, when the transfer of the immersion space from the fine motion stage WFS1 to the movable blade BL is complete, the main control apparatus 20 further drives the coarse motion stages WCS1, which hold the fine motion stage WFS1, in the +Y direction to the vicinity of the coarse motion stages WCS2, which are standing by and holding the fine motion stage WFS2 at the standby position discussed above. Thereby, as shown in FIG. 19B, the configuration transitions to the state wherein internal spaces of the coarse motion stages WCS1 house the center table 130 and the fine motion stage WFS1 is supported directly above the center table 130. Namely, the coarse motion stages WCS1 transport the fine motion stage WFS1 to a location directly above the center table 130. FIG. 20 is a plan view of the state of the exposure apparatus 100 at this time. However, the movable blade BL is not shown. The same also applies to other plan views.

Furthermore, the main control apparatus 20 drives the table main body 136 upward via the drive apparatus 132 of the center table 130 and thereby supports the fine motion stage WFS1 from below.

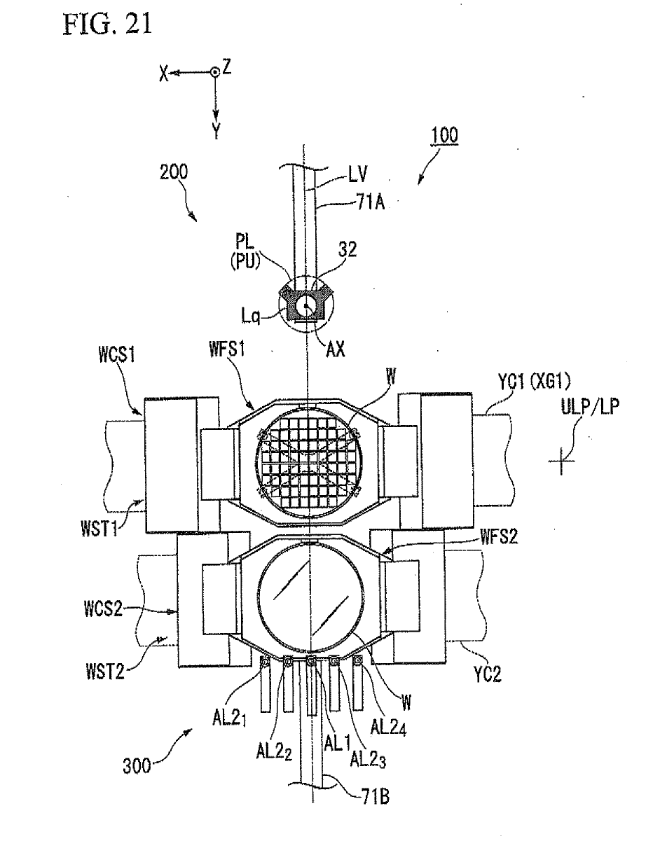

Next, in this state, as shown in FIG. 8(B) and FIG. 21, the main control apparatus 20 releases a lock mechanism (not shown) and moves the X coarse motion stages WCS1 along the X guides XG1 in opposite directions. Thereby, the fine motion stage WFS1 can be separated from the coarse motion stages WCS1. Accordingly, the roam control apparatus 20 can drive the table main body 136, which supports the fine motion stage WFS1, downward, as shown by the outlined arrow in FIG. 19C.

Subsequently, the main control apparatus 20 brings the two X coarse motion stages WCS1 into close proximity and moves them to the position at which they hold the fine motion stage.

Next, the main control apparatus 20 brings the coarse motion stages WCS2 substantially into contact with the coarse motion stages WCS1 and drives the fine motion stage WFS2 via the fine motion stage drive systems 52A, 52B in the −Y direction, as shown by the outlined arrow in FIG. 19D, and transfers (i.e., slides) the fine motion stage WFS2 from the coarse motion stages WCS2 to the coarse motion stages WCS1.

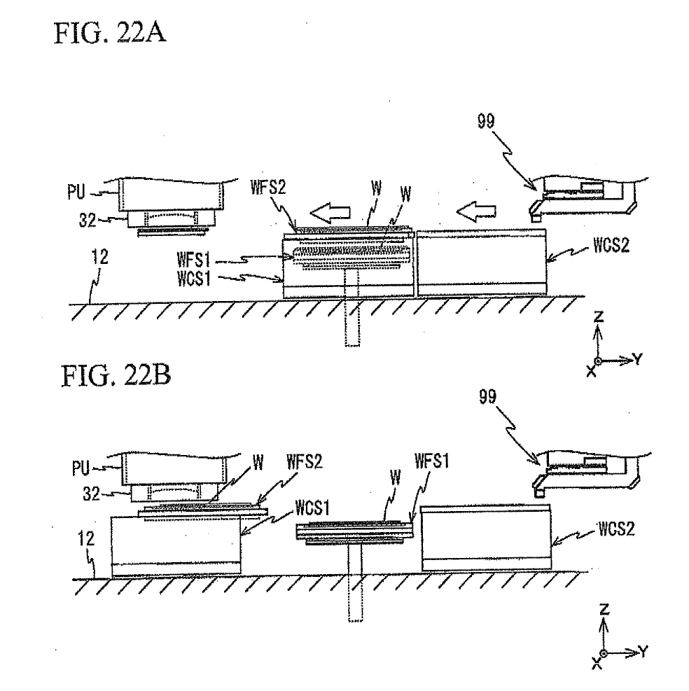

Next, the main control apparatus 20 moves the coarse motion stages WCS1, which held the fine motion stage WFS2, in the −Y direction, as shown by the outlined arrow in FIG. 22A, and transfers the immersion space, which is held between the movable blade BL and the tip lens 191, from the movable blade BL to the fine motion stage WFS2. The procedure of transferring the immersion space (i.e., the liquid Lq) is performed in the reverse order to the procedure of transferring the immersion area from the fine motion stage WFS1 to the movable blade BL discussed above.

Furthermore, prior to the start of an exposure, the main control apparatus 20 uses the pair of reticle alignment systems RA1, RA2, the pair of first fiducial marks on the measuring plate 86 of the fine motion stage WFS2, and the like, all of which were discussed above, to perform a reticle alignment using a procedure identical to that of a regular scanning stepper (e.g., the procedure disclosed in U.S. Pat. No. 5,646,413). FIG. 22B shows the fine motion stage WFS2, which is undergoing a reticle alignment, and the coarse motion stages WCS1, which hold the fine motion stage WFS2. Furthermore, based on the results of the reticle alignment and of the wafer alignment (i.e., the array coordinates of each shot region on the wafer W wherein the second fiducial mark serves as a reference), the main control apparatus 20 performs step-and-scan type exposure operations to transfer the pattern of the reticle R to the plurality of shot regions on the wafer W. These exposures are performed after the reticle alignment; first, the fine motion stage WFS2 is returned, to the −Y side and the shot regions on the wafer W are exposed in sequence starting with the +Y side shot region and ending with the −Y side shot region.

Operations, such as a-f below, are performed in parallel with the abovementioned transfer of the immersion space, the reticle alignment, and the exposures.

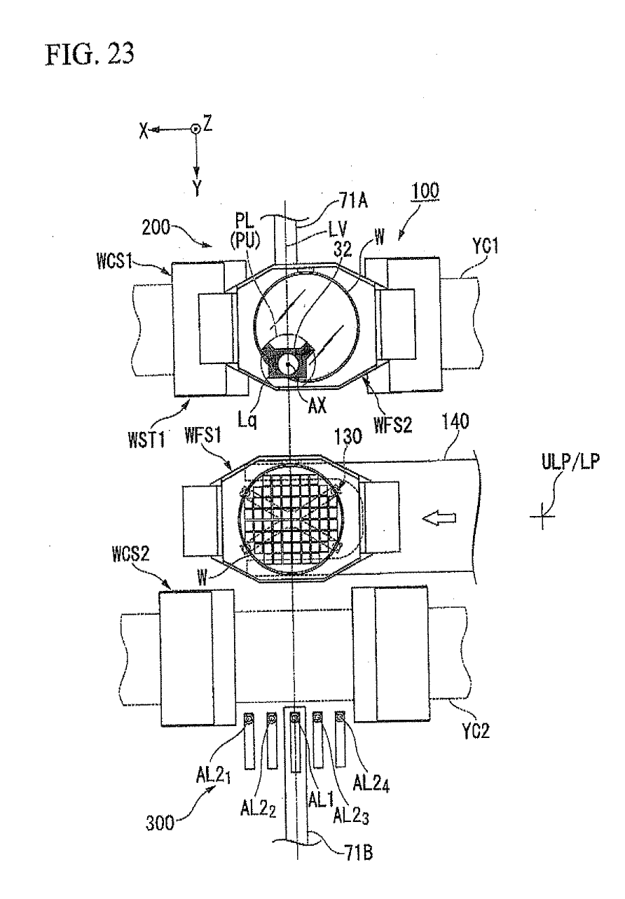

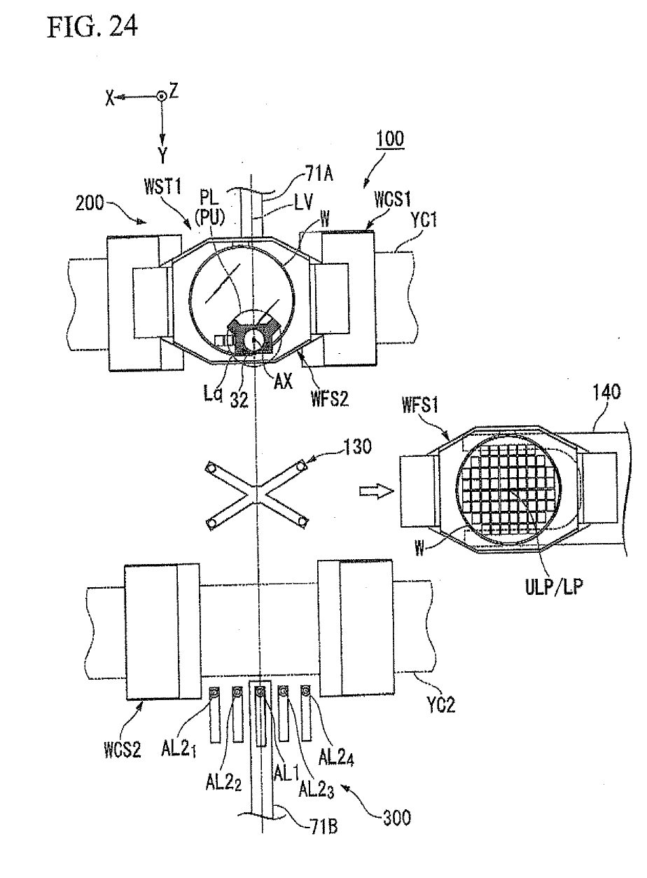

a. Namely, the main control apparatus 20 performs control such that a prescribed procedure drives the robot arm 140 in the X axial directions, the Y axial directions, and the Z axial directions (refer to the outlined arrows in FIG. 23 and FIG. 24), and the robot arm 140 transfers the fine motion stage WFS1, which holds the unexposed wafer W mounted on the table main body 136 of the center table 130, to the wafer exchange position ULP/LP. FIG. 24 shows the state wherein the fine motion stage WFS1 has been transferred to the wafer exchange position ULP/LP. At this time, the exposure of the wafer W on the fine motion stage WFS2 continues.

b. Furthermore, at a wafer exchange position, an unloading arm and a loading arm (both of which are not shown) exchange the exposed wafer Won the fine motion stage WFS2 with a new, unexposed wafer W. Here, as one example, the unloading arm and the loading aim each have a so-called Bernoulli chuck. Here, a table (not shown) is installed at the wafer exchange position and the wafer W is exchanged in the state wherein the fine motion stage WFS1 (or WFS2) is mounted on the table. When the fine motion stage WFS1 (or WFS2) is on the table, a pressure reducing chamber (i.e., a pressure reducing space), which is formed by the wafer holder (not shown) of the fine motion stage WFS1 and a rear surface of the wafer W, is connected to an air supply pump, which in turn is connected to a supply source of pressurized gas via a gas supply conduit and a piping, neither of which is shown. In addition, the pressure reducing chamber (i.e., the pressure reducing space), which is formed by the wafer holder (not shown) of the fine motion stage WFS2 and the rear surface of the wafer W, is connected to a vacuum pump via an air exhaust conduit and a piping, neither of which is shown. When the wafer is to be unloaded, the main control apparatus 20 operates the air supply pump to unchuck the wafer W from the wafer holder, and the pressurized gas blown out from below aids in chucking the wafer W via the Bernoulli chucks. Furthermore, in the pump stopped state (i.e., the non-operating state), including when the wafer is being chucked, the gas supply conduit is closed by the action of a check valve (not shown). Moreover, when the wafer is to be loaded, the main control apparatus 20 operates the vacuum pump, and thereby the gas inside the pressure reducing chamber is exhausted via the air exhaust conduit and the piping, the interior of the pressure reducing chamber transitions to a negative pressure, and the wafer holder begins chucking the wafer W. Furthermore, when the interior of the pressure reducing chamber reaches a prescribed pressure a negative pressure), the main control apparatus 20 stops the vacuum pump. When the vacuum pump stops, the action of the check valve (not shown) closes the air exhaust conduit. Accordingly, even if the pressure reducing chamber is maintained in the reduced pressure state and, for example, a tub, which is for vacuum suctioning the gas inside the pressure reducing chamber, is not connected to the fine motion stage WFS1 (or WFS2), the wafer holder still holds the wafer W. Consequently, the fine motion stage WFS1 (or WFS2) can be transferred unhindered and isolated from the coarse motion stages.

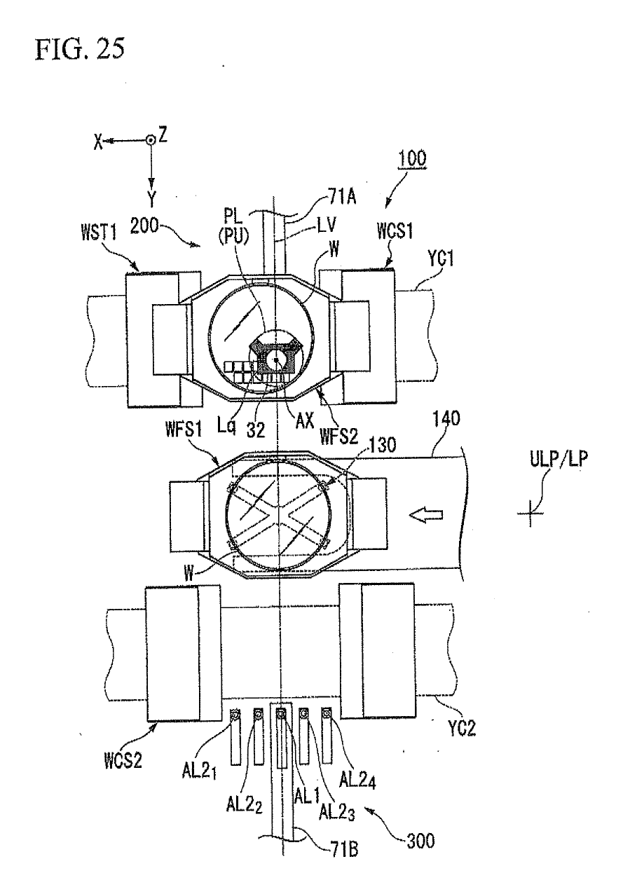

c. After the wafer exchange, the main control apparatus 20 performs control such that a prescribed procedure drives the robot arm 140 in the X axial directions, the Y axial directions, and the Z axial directions, and the robot arm 140 transports the fine motion stage WFS1, which holds the new wafer W, onto the table main body 136 of the center table 130. FIG. 25 shows the state wherein the transport of the fine motion stage WFS1 onto the center table 130 is complete. After the transport is complete, the main control apparatus 20 drives the table main body 136 of the center table 130 upward by a prescribed amount via the drive apparatus 132. At this time, the exposure of the wafer W on the fine motion stage WFS2 continues.

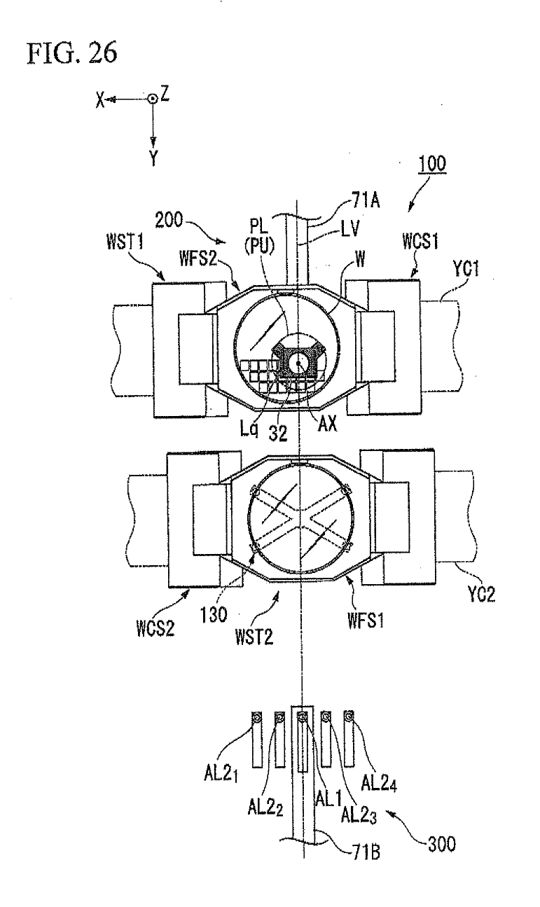

d. Next, the main control apparatus 20 drives the coarse motion stages WCS2, which were standing by in the vicinity of the alignment end position, in the −Y direction; thereby, the fine motion stage WFS1, which is supported on the table main body 136, is mounted on the coarse motion stages WCS2 as shown in FIG. 26. Subsequently, the table main body 136 is driven downward by a prescribed amount. Thereby, the fine motion stage WFS1 comes to he supported by the coarse motion stages WCS2.

e. Next, the main control apparatus 20 drives the coarse motion stages WCS2 in the +Y direction, and thereby the coarse motion stages WCS2 move to the measurement station 300.

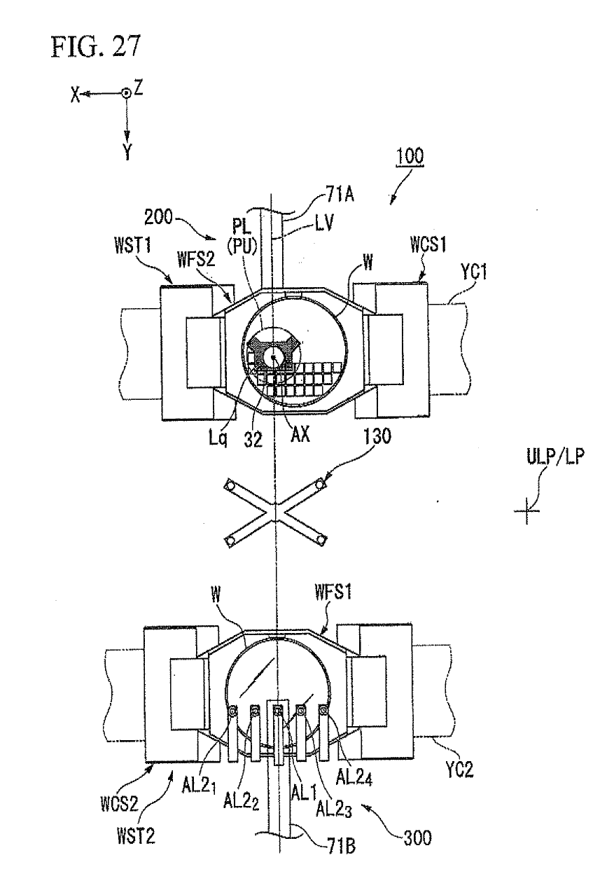

f. Subsequently, the detection of the second fiducial mark on the fine motion stage WFS1 supported by the coarse motion stages WCS2, the alignment of the wafer W on the fine motion stage WFS1, and the like are performed by procedures identical to those discussed above. Furthermore, the main control apparatus 20 converts the array coordinates of each shot region on the wafer W obtained as a result of the wafer alignment to array coordinates wherein the second fiducial mark serves as the reference. In this case, too, when the alignment is performed, the fine motion stage position measuring system 70B is used to measure the position of the fine motion stage WFS1. FIG. 27 shows the state wherein the wafer W is being aligned on the fine motion stage WFS1.

The state shown in FIG. 27 is identical to that shown in FIG. 14 discussed above, namely, the wafer W that is held by the fine motion stage WFS2 at the exposure station 200 is being exposed as discussed above and the wafer W that is held by the fine motion stage WFS1 at the measurement station 300 is being aligned.

Subsequently, the main control apparatus 20 sequentially uses the fine motion stages WFS1, WFS2 to repetitively perform parallel processes identical to those discussed above, and continuously performs the exposing process on a plurality of the wafers W.

Furthermore, the abovementioned embodiment explained a procedure that exchanges the fine motion stage, which is supported by the coarse motion stages WCS1 in the state wherein the internal spaces of the coarse motion stages WCS1 house the center table 130, but the present invention is not limited thereto; for example, a procedure may be adopted wherein once the coarse motion stages WCS2 have transferred the fine motion stage WFS2 to the table main body 136 at the position at which the internal spaces of the coarse motion stages WCS2 house the center table 130, the fine motion stage WFS1 is slid from the coarse motion stages WCS1, after which the coarse motion stages WCS1 are moved to the position at which the internal spaces of the coarse motion stages WCS1 house the center table 130 and the fine motion stage WFS1 is received from the table main body 136.

As was explained in detail above, according to the exposure apparatus 100 of the present embodiment, the main control apparatus 20 can transfer the fine motion stage (WFS1 or WFS2), which holds the wafer W that was exposed at the exposure station 200, from the coarse motion stages WCS1 to the table main body 136 of the center table 150 and can use the robot arm 140 to transport that fine motion stage on the table main body 136 to the wafer exchange position ULP/LP. In addition, the main control apparatus 20 can transfer the fine motion stage (WFS1 or WFS2), which holds the wafer W that was exposed at the exposure station ZOO, from the coarse motion stages WCS1 to the coarse motion stages WCS2, and then from the coarse motion stages WCS2 to the table main body 136, and can use the robot arm 140 to transport that faze motion stage on the table main body 136 to the wafer exchange position ULP/LP. In either case, a wafer exchange involves the flue motion stage that holds the exposed wafer W being transported to the wafer exchange position ULP/LP, which is at a position spaced apart from the pathway that links the exposure station 200 and the measurement station 300, after which the exposed wafer is exchanged with a new wafer. Accordingly, in parallel with at least part of the exposure operation performed on the wafer held on one of the fine motion stages, wafer exchange can be performed at the wafer exchange position ULP/LP; consequently, even if the object to be processed is, for example, a 450 mm wafer, which is difficult to exchange using techniques like those used conventionally, wafers can be processed with hardly a drop in throughput.

In addition, according to the exposure apparatus 100 of the present embodiment, a measurement surface, wherein the grating RG is formed, is provided to one surface of each of the fine motion stages WFS1, WFS2 such that this measurement surface is substantially parallel to the XY plane. The fine motion stage WFS1 (or WFS2) is held by the coarse motion stages WCS1 (or WCS2) such that it is capable of relative motion along the XY plane. Furthermore, the fine motion stage position measuring system 70A (or 70B) has X heads, which are disposed inside the spaces of the coarse motion stages WCS1 such that they oppose the measurement surface wherein the grating RG is formed, that radiate measurement beams to and receive the light of those measurement beams reflected from the measurement surface. Furthermore, the fine motion stage position measuring system 70A (or 70B) measures, based on the outputs of those X heads, the position at least within the XY plane (including the rotation in the θz directions) of the fine motion stage WFS1 (or WFS2). Consequently, the position of the fine motion stage WFS1 (or WFS2) within the XY plane can be accurately measured using the so-called rear surface measurement technique. Furthermore, the main control apparatus 20 drives the fine motion stage WFS1 (or WFS2) independently or integrally with the coarse motion stages WCS1 (or WCS2) based on the position measured by the fine motion stage position measuring system 70A (or 70B) via either the fine motion stage drive system 52A or the fine motion stage drive system 52A and the coarse, motion stage drive system 51A (or via either the fine motion stage drive system 52B or the fine motion stage drive system 52B and the coarse motion stage drive system 51B). In addition, as discussed above, there is no need to provide a vertically moving member on the fine motion stage, and therefore even adopting the abovementioned rear surface measurement technique poses no particular obstacles.

In addition, in the present embodiment, transporting the wafer W in the state wherein it is held by the fine motion stages WFS1, WFS2 makes it possible to easily transport the wafer W, which is thin and has a large surface area, and thereby further helps to improve throughput.

In addition, according to the exposure apparatus 100 of the present embodiment, the fine motion stage WFS1 (or WFS2) can be accurately driven, which makes it possible to accurately drive the wafer W mounted on the fine motion stage WFS1 (or WFS2) synchronously with the reticle stage RST (i.e., the reticle R) and thereby to accurately transfer the pattern on the reticle R to the wafer W via a scanning exposure.

The above text explained the embodiments according to the present invention, referencing the attached drawings, but of course the present invention is not limited to these embodiments. Each of the constituent members, shapes, and combinations described in the embodiments discussed above are merely exemplary, and it is understood that variations and modifications based on, for example, design requirements may be effected without departing from the spirit and scope of the invention.

For example, the abovementioned embodiment adopts a configuration that uses the stage apparatus ST that comprises both the first and second stage units SU1, SU2, but the present invention is not limited thereto; for example, as shown in FIG. 5, the present invention can also be adapted to a case wherein only one stage unit is used. In such a case, a procedure that transfers the fine motion stage WFS1 between the X coarse motion stages WCS1 and a transport apparatus (not shown) should be employed. In that case, the movable blade BL discussed above may be used in the transfer of the immersion space (i.e., the liquid Lq) held between the movable blade BL and the tip lens 191, or a configuration may be adopted wherein a transfer member for transferring the immersion space is provided to the Y coarse motion stage YC1. If such a transfer member is provided, then its front surface should be substantially flush with the upper surface of the wafer and it should be installed adjacent to the fine motion stage WFS1 with a microgap interposed therebetween, and, when the fine motion stage WFS1 is moved to the measurement station 300, the transfer member should be disposed at the position directly below the projection optical system PL where the immersion space (i.e., the liquid Lq) is transferred.

In addition, in the abovementioned embodiment, the grating is disposed on the upper surface of one of the fine motion stages, namely, on the surface that opposes the wafer, but the present invention is not limited thereto; for example, the grating may be formed in the wafer holder, which holds the wafer. In such a case, even if the wafer holder expands during an exposure or if a mounting position deviates with respect to the fine motion stage, it is possible to track this deviation and still measure the position of the wafer holder (i.e., the wafer). In addition, the grating may be disposed on the lower surface of one of the fine motion stages; in such a case, the measurement beams radiated from the encoder heads would not travel through the interior of the fine motion stage and, therefore, the fine motion stage would not have to be a solid member wherethrough the light can transmit, the interior of the fine motion stage could have a hollow structure wherein piping, wiring, and the like can be disposed, and the fine motion stage could be made more lightweight.

In addition, in the abovementioned embodiment, the fine motion stages WFS1, WFS2 can be driven in directions corresponding to a total of six degrees of freedom, but the present invention is not limited thereto; for example, any number of degrees of freedom is acceptable as long as the fine motion stages WFS1, WFS2 can move at least within a two dimensional plane that is parallel to the XY plane. In addition, the fine motion stages WFS1, WFS2 may be supported contactually by the coarse motion stages WCS1, WCS2. Accordingly, the fine motion stage drive systems that drive the fine motion stages with respect to the coarse motion stages or a relay stage may each comprise a combination of, for example, a rotary motor and a ball screw (or a feed screw).

In addition, in the abovementioned embodiment, as one example of the measurement of the wafer W, an alignment mark measurement (i.e., a wafer alignment) is performed at the measurement station 300; however, in addition thereto (or instead), a surface position measurement that measures the front surface of the wafer W in the directions of the optical axis AX of the projection optical system PL may be performed. In such a case, the surface position measurement of the upper surface of the fine motion stage that holds the wafer may be performed simultaneously with the above surface position measurement, as disclosed in, for example, U.S. Patent Application Publication No. 2008/0088843; furthermore, based on these results, the focus and leveling of the wafer W during an exposure may be controlled.

In addition, the abovementioned embodiment explained a case wherein the exposure apparatus 100 is a liquid immersion type exposure apparatus, but the present invention is not limited thereto; for example, the present invention can be suitably adapted also to a dry type exposure apparatus that exposes the wafer W without transiting any liquid (i.e., water).

Furthermore, the abovementioned embodiment explained a case wherein the present invention is adapted to a scanning stepper, but the present invention is not limited thereto; for example, the present invention may also be adapted to a static type exposure apparatus, such as a stepper. Unlike the case wherein encoders measure the position of a stage whereon an object to be exposed is mounted and the position of the stage is measured using an interferometer, it is possible, even in the case of a stepper and the like, to reduce the generation of position measurement errors owing to air turbulence to virtually zero, and therefore to position the stage with high accuracy based on the measurement values of the encoder; as a result, a reticle pattern can be transferred to an object with high accuracy. In addition, the present invention can also be adapted to a step-and-stitch type reduction projection exposure apparatus that stitches shot regions together.

In addition, the projection optical system FL in the exposure apparatus 100 of the embodiment mentioned above is not limited to a reduction system and may be a unity magnification system or an enlargement system; furthermore, the projection optical system PL is not limited to a dioptric system and may be a catoptric system or a catadioptric system; in addition, the image projected thereby may be either an inverted image or an erect image.

In addition, the illumination light IL is not limited to ArF excimer laser light (with a wavelength of 193 nm), but may be ultraviolet light, such as KrF excimer laser light (with a wavelength of 248 nm), or vacuum ultraviolet light, such as F₂ laser light (with a wavelength of 157 nm). For example, as disclosed in U.S. Pat. No. 7,023,610, higher harmonics may also be used as the vacuum ultraviolet light by utilizing, for example, an erbium (or erbium-ytterbium) doped fiber amplifier to amplify single wavelength Laser light in the infrared region or the visible region that is generated from a DFB semiconductor laser or a fiber laser, and then using a nonlinear optical crystal for wavelength conversion to convert the output laser light to ultraviolet light.

In addition, in the exposure apparatus of the present invention, the illumination light IL thereof is not limited to light with a wavelength of 100 nm or greater; of course, light with a wavelength of less than 100 nm may be used. For example, the present invention can be adapted to an EUV exposure apparatus that uses extreme ultraviolet (EUV) light in the soft X-ray region (e.g., light in a wavelength band of 5-15 nm). In addition, the present invention can also be adapted to an exposure apparatus that uses a charged particle basin, such as an electron beam or an ion beam.

In addition, in the embodiment discussed above an optically transmissive mask (i.e., a reticle) wherein a prescribed shielding pattern (or a phase pattern or dimming pattern) is formed on an optically transmissive substrate is used; however, instead of such a reticle, an electronic mask—including variable shaped masks, active masks, and digital micromirror devices (DMDs), which are also called image generators and are one type of non-light emitting image display devices (i.e., spatial light modulators)—may be used wherein a transmissive pattern, a reflective pattern, or a light emitting pattern is formed based on electronic data of the pattern to be exposed, as disclosed in, for example, U.S. Pat. No. 6,778,257. In the case wherein a variable shaped mask is used, the stage whereon the wafer, a glass plate, or the like is mounted is scanned with respect to the variable shaped mask, and therefore effects equivalent to those of the abovementioned embodiment can be obtained by using the encoder system and a laser interferometer system to measure the position of the stage.

Furthermore, in the abovementioned embodiment, the object whereon the pattern is to be formed (i.e., the object to be exposed by being irradiated with an energy beam) is not limited to a wafer, and may be a glass plate, a ceramic substrate, a film member, or some other object such as a mask blank.

The application of the exposure apparatus is not limited to an exposure apparatus for fabricating semiconductor devices, but can be widely adapted to, for example, an exposure apparatus for fabricating liquid crystal devices, wherein a liquid crystal display device pattern, is transferred to a rectangular glass plate, as well as to exposure apparatuses for fabricating organic electroluminescent displays, thin film magnetic heads, image capturing devices (e.g., CCDs), micromachines, and DNA chips. In addition to fabricating microdevices like semiconductor devices, the present invention can also be adapted to an exposure apparatus that transfers a circuit pattern to a glass substrate, a silicon wafer, or the like in order to fabricate a reticle or a mask used by a light exposure apparatus, an EUV exposure apparatus, an X-ray exposure apparatus, an electron beam exposure apparatus, and the like.

As described above, the exposure apparatus 100 of the present embodiment is manufactured by assembling various subsystems, including all of the constituent elements, such that prescribed mechanical, electrical, and optical accuracies are maintained. To ensure these various accuracies, adjustments are performed before and after this assembly, including an adjustment to achieve optical accuracy for the various optical systems, an adjustment to achieve mechanical accuracy for the various mechanical systems, and an adjustment to achieve electrical accuracy for the various electrical systems. The process of assembling the exposure apparatus from the various subsystems includes, for example, the connection of mechanical components, the wiring and connection of electrical circuits, and the piping and connection of the pneumatic circuits among the various subsystems. Naturally, prior to performing the process of assembling the exposure apparatus from these various subsystems, there are also the processes of assembling each individual subsystem. When the process of assembling the exposure apparatus from the various subsystems is complete, a comprehensive adjustment is performed to ensure the various accuracies of the exposure apparatus as a whole. Furthermore, it is preferable to manufacture the exposure apparatus in a clean room wherein, for example, the temperature and the cleanliness level are controlled.

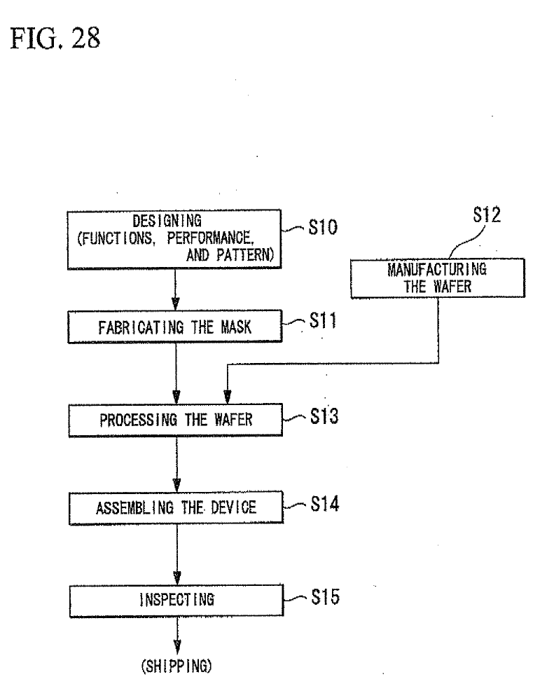

The following text explains a method of fabricating microdevices using the exposure apparatus 100 and the exposing method according to the above-described embodiments in a lithographic process. FIG. 28 depicts a flow chart of an example of fabricating a microdevice (i.e., a semiconductor chip such as an IC or an LSI; a liquid crystal panel; a CCD; a thin film magnetic head; a micromachine; and the like).

First, in a step S10 (i.e., a designing step), the functions and performance of the microdevice (e.g., the circuit design of the semiconductor device), as well as the pattern for implementing those functions, are designed. Next, in a step S11 (i.e., a mask fabricating step), the mask (i.e., the reticle), wherein the designed circuit pattern is formed, is fabricated. Moreover, in a step S12 (i.e., a wafer manufacturing step), the wafer is manufactured using a material such as silicon.

Next, in a step S13 (i.e., a wafer processing step), the actual circuit and the like are formed on the wafer by, for example, lithographic technology (discussed later) using the mask and the wafer that were prepared in the steps S10-S12. Then, in a step S14 (i.e., a device assembling step), the device is assembled using the wafer that was processed in the step S13. In the step S14, processes are included as needed, such as the dicing, bonding, and packaging (i.e., chip encapsulating) processes. Lastly, in a step S15 (i.e., an inspecting step), inspections are performed, for example, an operation verification test and a durability test of the microdevice fabricated in the step S14. Finishing such processes completes the fabrication of the microdevice, which is then shipped.

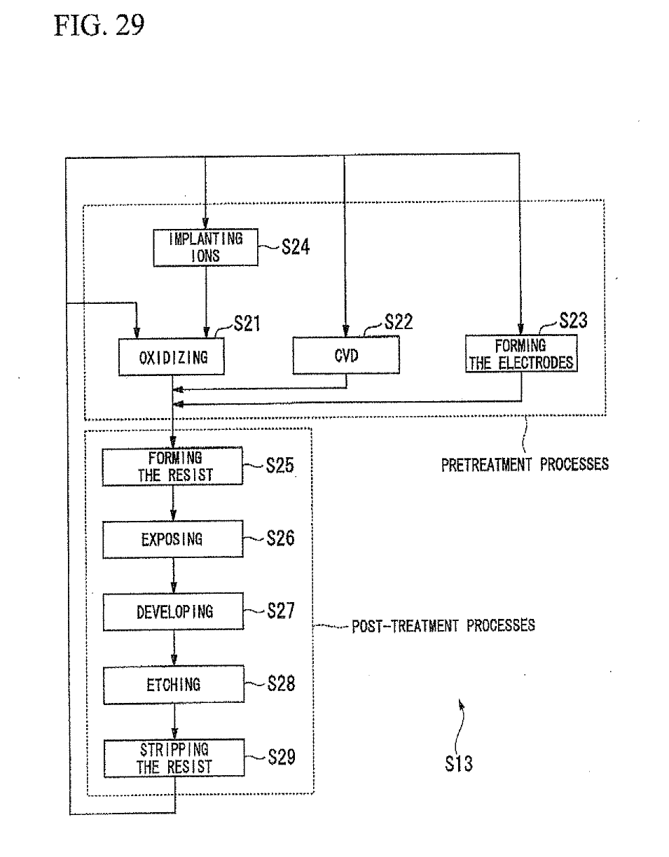

FIG. 29 depicts one example of the detailed process of the step S13 for the case of a semiconductor device.

In a step S21 (i.e., an oxidizing step), the front surface of the wafer is oxidized. In a step S22 (i.e., a CVD step), an insulating film is formed on the front surface of the wafer. In a step S23 (i.e., an electrode forming step), an electrode is formed on the wafer by vacuum deposition. In a step S24 (i.e., an ion implanting step), ions are implanted in the wafer. The above steps S21-S24 constitute the pretreatment processes of the various stages of wafer processing and are selectively performed in accordance with the processes needed in the various stages.

When the pretreatment processes discussed above in each stage of the wafer process are complete, post-treatment processes are performed as described below. In the post-treatment processes, the wafer is first coated with a photosensitive agent in a step S25 (i.e., a resist forming step). Continuing, in a step S26 (i.e., an exposing step), the circuit pattern of the mask is transferred onto the wafer by the lithography system (i.e., the exposure apparatus) and the exposing method explained above. Next, in a step S27 (i.e., a developing step), the exposed wafer is developed; further, in a step S28 (i.e., an etching step), the uncovered portions are removed by etching, excluding the portions where the resist remains. Further, in a step S29 (i.e., a resist removing step), etching is finished and the resist that is no longer needed is stripped. Circuit patterns are superposingly formed on the wafer by repetitively performing the pretreatment and post-treatment processes.

In a stage apparatus according to one embodiment of the present invention, a pair of second moving bodies moves in opposite directions along a guide member; thereby, it is possible to easily release and separate a holding member, which is supported by the pair of second moving bodies, from the pair of second moving bodies while holding an object as is.

In an exposure apparatus according to one embodiment of the present invention, even if a large substrate is being handled, it is possible to easily release and separate a holding member, which holds a substrate and is supported by a pair of second moving bodies, from the pair of second moving bodies while holding a substrate as is, and thereby to exchange the holding member.

In a driving method according to one embodiment of the present invention, a pair of second moving bodies is moved in opposite directions along a guide member; thereby, it is possible to easily release and separate a holding member, which is supported by the pair of second moving bodies, from the pair of second moving bodies while holding the object as is.

In an exposing method according to one embodiment of the present invention, even if a large substrate is being handled, it is possible to easily release and separate a holding member, which holds a substrate and is supported by a pair of second moving bodies, from the pair of second moving bodies while holding a substrate as is, and thereby to exchange the holding member.

1. A stage apparatus, comprising:
a first moving body, which comprises a guide member that extends in first directions, that moves in second directions, which are substantially orthogonal to the first directions;
two second moving bodies, which are provided along the guide member such that they are independently moveable in the first directions, that move in the second directions together with the guide member by the movement of the first moving body; and
a holding member that holds an object and is supported by the two second moving bodies such that it is capable of moving within a two dimensional plane that includes at least the first directions and the second directions.

2. A stage apparatus according to claim 1, wherein
the holding member has a measurement surface that can be measured from a surface on the reverse side of a holding surface whereto the object is held and comprises a measuring apparatus that measures the measurement surface from the reverse side of the holding surface and obtains information related to the position of the holding member.

3. A stage apparatus according to claim 2, wherein
at least part of the holding member is a solid part wherethrough light can travel and the holding member has the measurement surface, which is disposed on the holding surface side and opposing the solid part;
a grating, whose directions of periodicity are parallel to at least one of the directions selected from the group consisting of the first directions and the second directions, is disposed on the measurement surface; and
the measuring apparatus radiates a measurement beam from the reverse side to the measurement surface, receives the returning beam of the measurement beam from the grating, and measures the position of the holding member within the two dimensional plane.

4. A stage apparatus according to claim 2, wherein
the measuring apparatus measures information related to the position of the holding member at a processing position at which a prescribed process is performed on the object.

5. A stage apparatus according to claim 1 comprising:
a drive apparatus, which is provided between the pair of second moving bodies and the holding member, that drives the holding member with respect to the pair of second moving bodies in six degrees of freedom.

6. A stage apparatus according to any one claim of claim 1, comprising:
first and second stage units, each of which has the first moving body and the second moving bodies;
wherein,
the first and second stage units each support a separate holding member and are each capable of moving independently.

7. A stage apparatus according to claim 6, comprising:
a first measuring apparatus that measures information related to the position of the holding member, which is supported by the first stage unit, from the reverse side of the holding surface of the object on the holding member; and
a second measuring apparatus that measures information related to the position of the holding member, which is supported by the second stage unit, from the reverse side of the holding surface of the object on the holding member at a position other than that of the first measuring apparatus.

8. A stage apparatus according to claim 7, wherein
the first measuring apparatus measures information related to the position of the object at a first processing position at which a first process is performed on the object; and
the second measuring apparatus measures information related to the position of the object at a second processing position at which a second process is performed prior to the first process.

9. A stage apparatus according to claim 6, wherein
the holding member comprises a control apparatus that performs control such that the holding member is exchanged between the first stage unit and the second stage unit.

10. A stage apparatus according to claim 9, comprising:
a support apparatus, which supports the holding member between the first processing position and the second processing position.

11. A stage apparatus according to claim 10, wherein
when the holding member is transferred between the support apparatus and the second moving bodies, the control apparatus moves the pair of second moving bodies in opposite directions on the guide member.

12. An exposure apparatus, which exposes with an energy beam an object held by a stage apparatus, wherein
a stage apparatus according to claim 1 serves as the stage apparatus.

13. An exposure apparatus according to claim 12, wherein
the exchange of the object is performed integrally with the holding member.

14. An exposure apparatus according to claim 12 further comprising:
an optical member, which has an emergent surface wherefrom the energy beam emerges; and
a liquid immersion apparatus, which comprises a liquid immersion member that supplies a liquid to a space between the optical member and the holding member held by the second moving bodies.

15. A device fabricating method, comprising:
a process that exposes an object using an exposure apparatus according to claim 12; and
a process that develops the exposed object.

16. A driving method that moves a holding member, which holds an object, within a two-dimensional plane that includes first directions and second directions orthogonal to the first directions, comprising:
moving the first moving body, which comprises a guide member that extends in the first directions, in the second directions;
moving two second moving bodies, which are provided such that they move independently in the first directions along the guide member, in the second directions together with the guide member by the movement of the first moving body; and
supporting the holding member, which holds the object, by the two second moving bodies, synchronously moves the two second moving bodies along the guide member, and moves the holding member in the first directions.

17. A driving method according to claim 16, comprising:
providing first and second stage units, each of which has the first moving body and the second moving bodies; and
independently driving one of the holding members, which is supported by the first stage unit, and the other of the holding members, which is supported by the second stage unit, within a two-dimensional plane.

18. A driving method according to claim 16, comprising:
measuring information related to the position of the holding member from the reverse side of a holding surface of the object on the holding member.

19. An exposing method that drives a stage, which holds an object, and exposes the object with an energy beam, comprising:
driving the stage using a driving method according to claim 16.

20. A device fabricating method, comprising:
exposing an object using an exposing method according to claim 19; and
developing the exposed object.
